(19) United States
(12) Patent Application Publication
(10) Pub. No.: US 2014/0333878 A1
(43) Pub. Date: Nov. 13, 2014

(54) LIQUID CRYSTAL DISPLAY AND MANUFACTURING METHOD THEREOF

(71) Applicant: Samsung Display Co., Ltd., Yongin-si (KR)

(72) Inventors: Hee Keun LEE, Yongin-city (KR); Yeun Tae KIM, Yongin-si (KR); Soon Joon RHO, Yongin-si (KR)

(73) Assignee: Samsung Display Co., Ltd., Yongin-si (KR)

(21) Appl. No.: 14/248,903

(22) Filed: Apr. 9, 2014

(30) Foreign Application Priority Data
May 10, 2013 (KR) 10-2013-0053269

(51) Int. Cl. G02F 1/1337

(52) U.S. Cl. CPC G02F 1/1337
USPC 349/123; 438/30

(57) ABSTRACT

A liquid crystal display is disclosed. The liquid crystal display may include an insulation substrate a pixel electrode formed on the insulation substrate a lower alignment layer formed on the pixel electrode and includes an inorganic alignment layer formed of an inorganic insulating material, a liquid crystal layer disposed in a microcavity formed on the lower alignment layer, an upper alignment layer formed along a side and an upper surface of the microcavity and includes an inorganic alignment layer formed of an inorganic insulating material, and a common electrode formed on the upper alignment layer. The upper alignment layer and the lower alignment layer enclose the liquid crystal layer. A method of manufacturing a liquid crystal display is also disclosed.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. For example, this application claims priority to and the benefit of Korean Patent Application No. 10-2013-0053269 filed in the Korean Intellectual Property Office on May 10, 2013, the entire contents of which are incorporated herein by reference.

### BACKGROUND

1. Field

The present disclosure relates to a liquid crystal display and a manufacturing method thereof, and more particularly, to a liquid crystal display having a liquid crystal layer (nano crystal) present in a microcavity and a manufacturing method thereof.

2. Description of the Related Technology

The liquid crystal display is a type of flat panel display widely used in recent years. The liquid crystal display includes two display panels in which a field generating electrode such as a pixel electrode and a common electrode are formed, and in which a liquid crystal layer is interposed between the two display panels. The liquid crystal display functions by applying a voltage to the field generating electrode to generate an electric field in the liquid crystal layer, determining an alignment of liquid crystal molecules of the liquid crystal layer by the electric field, and controlling polarization of incident light to display an image. A liquid crystal display having an EM (Embedded Microcavity) structure (nano crystal structure) is formed on a sacrificial layer using a photo resist, coating an upper portion with a supporting member, and then removing the sacrificial layer and filling the empty space with liquid crystal to form a display. In the empty space (microcavity) formed by removing the sacrificial layer, an alignment layer is formed to control the liquid crystal. In this case, the alignment layer is also injected in the microcavity. However, there are problems in that it takes much time to inject the alignment layer and the alignment layer is not uniformly coated on the walls of the microcavity.

The above information disclosed in this Background section is only for enhancement of understanding of the background and therefore it may contain information that does not form the prior art that is already known in this country to a person of ordinary skill in the art.

### SUMMARY OF CERTAIN INVENTIVE ASPECTS

In one aspect, a liquid crystal display is provided. The liquid crystal display may use an inorganic alignment layer as an alignment layer in which liquid crystal molecules disposed in a microcavity are arranged.

In another aspect, a method of manufacturing a liquid crystal display is provided.

In another aspect, a liquid crystal display is provided that includes, for example, an insulation substrate, a pixel electrode formed on the insulation substrate, a lower alignment layer disposed on the pixel electrode and is an inorganic alignment layer formed of an inorganic insulating material, a liquid crystal layer disposed in a microcavity formed on the lower alignment layer, an upper alignment layer formed along a side and an upper surface of the microcavity and is an inorganic alignment layer formed of an inorganic insulating material, and a common electrode formed on the upper alignment layer, in which the upper alignment layer and the lower alignment layer enclose the liquid crystal layer.

In some embodiments, the inorganic insulating material may include at least one of silicon oxide (SiOx), silicon nitride (SiNx), silicon carbide (SiCx), amorphous silicon (a-Si), and FDLC (fluorinated diamond-like carbon). In some embodiments, the inorganic alignment layer may be formed of silicon oxide (SiOx). In some embodiments, a composition ratio of the silicon oxide (SiOx), x may have a value between about 2.3 and about 2.4. In some embodiments, a thickness of the upper alignment layer or the lower alignment layer may be between about 400 Å and about 1000 Å. In some embodiments, a dielectric constant of the upper alignment layer or the lower alignment layer may be between about 5 and about 7. In some embodiments, the upper alignment layer and the lower alignment layer may overlap between adjacent microcavities. In some embodiments, the upper alignment layer and the common electrode may be curved along the microcavity. In some embodiments, the liquid crystal display may further include a roof layer which covers the common electrode and includes a pillar. In some embodiments, the liquid crystal display may further include an upper insulating layer which covers the roof layer. In some embodiments, the liquid crystal display may further include a lower insulating layer which is disposed between the common electrode and the roof layer.

In another aspect, a method of manufacturing a liquid crystal display is provided, which includes, for example, forming a pixel electrode on an insulation substrate, forming a lower alignment layer with an inorganic alignment material so as to cover the pixel electrode, forming a sacrificial layer having a side and an upper surface on the lower alignment layer, forming an upper alignment layer with an inorganic alignment material on the side and the upper surface of the sacrificial layer, forming a common electrode to cover the upper alignment layer, forming a roof layer including a pillar to cover the common electrode, forming a liquid crystal injection hole to expose the sacrificial layer, removing the sacrificial layer exposed through the liquid crystal injection hole to form a microcavity, and injecting liquid crystal molecules in the microcavity to form a liquid crystal layer.

In some embodiments, the inorganic insulating material may include at least one of silicon oxide (SiOx), silicon nitride (SiNx), silicon carbide (SiCx), amorphous silicon (a-Si), and FDLC (fluorinated diamond-like carbon). In some embodiments, the inorganic alignment layer may be formed of silicon oxide (SiOx). In some embodiments, a composition ratio of the silicon oxide (SiOx), x may have a value of 2.3 or larger and 2.4 or smaller. In some embodiments, a thickness of the upper alignment layer or the lower alignment layer may be between about 400 Å and 1000 Å. In some embodiments, a dielectric constant of the upper alignment layer or the lower alignment layer may be between about 5 and 7. In some embodiments, the upper alignment layer or the lower alignment layer may be deposited under a condition that a deposition temperature is about 100° C., a deposition pressure is about 1.5 torr, nitrogen (N₂O) is about 7000 sccm, SiH₄ is about 120 sccm and the deposition time may be between about 27 seconds and about 75 seconds. In some embodiments, the forming of the lower alignment layer or the upper alignment layer may include removing the inorganic alignment layer deposited on a pad. In some embodiments, the forming of the lower alignment layer or the upper alignment layer may further include performing washing after forming the inorganic alignment layer with the inorganic alignment material.

In another aspect, as an alignment layer which initially aligns the liquid crystal molecules disposed in the microcavity, the inorganic alignment layer is used so that a process of injecting the alignment layer is not used, which may reduce the alignment layer formation step and shorten the manufacturing time. Further, the inorganic alignment layer is uniformly formed in the microcavity. In some embodiments, the alignment force of the inorganic alignment layer does not fall behind the alignment force of an alignment layer using the polyimide, so that there is no problem in the initial arrangement of the liquid crystal molecule.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a layout view of a liquid crystal display according to an exemplary embodiment of the present disclosure.

FIG. 2 is a cross-sectional view taken along the line II-II of FIG. 1.

FIG. 3 is a cross-sectional view taken along the line of FIG. 1.

FIG. 4 is a diagram illustrating a step in a manufacturing method of the liquid crystal display according to the exemplary embodiment of FIG. 1.

FIG. 5 is a diagram illustrating a step in a manufacturing method of the liquid crystal display according to the exemplary embodiment of FIG. 1.

FIG. 6 is a diagram illustrating a step in a manufacturing method of the liquid crystal display according to the exemplary embodiment of FIG. 1.

FIG. 7A is a layout view corresponding to FIG. 1.

FIG. 7B is a cross-sectional view corresponding to FIG. 2.

FIG. 8A is a diagram illustrating a manufacturing step in the manufacturing method of the liquid crystal display of FIG. 1.

FIG. 8B corresponds to FIG. 2 and illustrates a cross-sectional view of the liquid crystal display formed through FIG. 8A.

FIG. 9A is a cross-sectional view illustrating a step in a manufacturing method of the liquid crystal display according to the exemplary embodiment of FIG. 1.

FIG. 9B is a cross-sectional view illustrating a step in a manufacturing method of the liquid crystal display according to the exemplary embodiment of FIG. 1.

FIG. 10A illustrates a step in the manufacturing method of the liquid crystal display of FIG. 1.

FIG. 10B illustrates a perspective view of a step in the manufacturing method of the display of FIG. 10A and FIG. 1.

FIG. 10C illustrates a cross-sectional view of a step in the manufacturing method of the display of FIG. 10A and FIG. 1.

FIG. 10D illustrates a cross-sectional view of a step in the manufacturing method of the display of FIG. 10A and FIG. 1.

FIG. 11A illustrates a step in the manufacturing method of the liquid crystal display of FIG. 1.

FIG. 11B illustrates a perspective view of the manufacturing method of the liquid crystal display of FIG. 1 and FIG. 11A.

FIG. 11C illustrates a cross-sectional view of the manufacturing method of the liquid crystal display of FIG. 1 and FIG. 11A.

FIG. 11D illustrates a cross-sectional view of the manufacturing method of the liquid crystal display of FIG. 1 and FIG. 11A.

FIG. 12A illustrates a step in the manufacturing method of the liquid crystal display of FIG. 1.

FIG. 12B illustrates a perspective view of the manufacturing method of the liquid crystal display of FIG. 1 and FIG. 12A.

FIG. 12C illustrates a cross-sectional view of the manufacturing method of the liquid crystal display of FIG. 1 and FIG. 12A.

FIG. 12D illustrates a cross-sectional view of the manufacturing method of the liquid crystal display of FIG. 1 and FIG. 12A.

FIG. 13A illustrates a step in the manufacturing method of the liquid crystal display of FIG. 1.

FIG. 13B illustrates a perspective view of the manufacturing method of the liquid crystal display of FIG. 1 and FIG. 13A.

FIG. 13C illustrates a cross-sectional view of the manufacturing method of the liquid crystal display of FIG. 1 and FIG. 13A.

FIG. 13D illustrates a cross-sectional view of the manufacturing method of the liquid crystal display of FIG. 1 and FIG. 13A.

FIG. 14A illustrates a step in the manufacturing method of the liquid crystal display of FIG. 1.

FIG. 14B illustrates a perspective view of the manufacturing method of the liquid crystal display of FIG. 1 and FIG. 14A.

FIG. 14C illustrates a prospective view of the manufacturing method of the liquid crystal display of FIG. 1 and FIG. 14A with microcavities.

FIG. 14D illustrates a cross-sectional view of the manufacturing method of the liquid crystal display of FIG. 1 and FIG. 14A with microcavities.

FIG. 14E illustrates a cross-sectional view of the manufacturing method of the liquid crystal display of FIG. 1 and FIG. 14A with microcavities.

FIG. 15 is a diagram illustrating a step of forming an alignment layer in the liquid crystal display according to a Comparative Example.

FIG. 16 is a cross-sectional view illustrating an alignment layer which is actually formed in the liquid crystal display according to the Comparative Example.

FIG. 17 is a diagram illustrating a step of forming an alignment layer in the liquid crystal display according to the exemplary embodiment of the present disclosure.

FIG. 18 is another diagram illustrating a step of forming an alignment layer in the liquid crystal display according to the exemplary embodiment of the present disclosure.

FIG. 19 is a cross-sectional view illustrating the alignment layer manufactured as illustrated in FIGS. 17 and 18.

FIG. 20 is a flowchart illustrating a manufacturing method of a liquid crystal display according to an exemplary embodiment.

FIG. 21 is a diagram illustrating a characteristic of an alignment layer according to an exemplary embodiment of the present disclosure.

FIG. 22 illustrates a correlation between a thickness of the inorganic alignment layer and a composition of the inorganic alignment layer.

FIG. 23 illustrates a correlation between a thickness of the inorganic alignment layer of the silicon oxide (SiOx) and an OH concentration of the alignment layer.

FIG. 24 is a diagram illustrating a characteristic of an alignment layer according to the exemplary embodiment of FIG. 21.

FIG. 25 is a diagram illustrating a characteristic of an alignment layer according to the exemplary embodiment of FIG. 21.

FIG. 26 is a diagram illustrating a characteristic of an alignment layer according to the exemplary embodiment of FIG. 21.

FIG. 27 is a diagram illustrating a characteristic of an alignment layer according to the exemplary embodiment of FIG. 21.

FIG. 28 is a diagram illustrating a characteristic of an alignment layer according to the exemplary embodiment of FIG. 21.

FIG. 29 is a diagram illustrating a characteristic of an alignment layer according to the exemplary embodiment of FIG. 21.

FIG. 30 is a diagram illustrating a characteristic of an alignment layer according to the exemplary embodiment of FIG. 21.

FIG. 31 is a diagram illustrating a characteristic of an alignment layer according to the exemplary embodiment of FIG. 21.

FIG. 32 is a diagram illustrating a characteristic of an alignment layer according to the exemplary embodiment of FIG. 21.

FIG. 33 is a diagram illustrating a characteristic of an alignment layer according to the exemplary embodiment of FIG. 21.

FIG. 34 is a diagram illustrating a characteristic of an alignment layer according to the exemplary embodiment of FIG. 21.

FIG. 35 is a diagram illustrating a characteristic of an alignment layer according to the exemplary embodiment of FIG. 21.

FIG. 36 is a cross-sectional view illustrating a liquid crystal display according to another exemplary embodiment of the present disclosure.

FIG. 37 is a cross-sectional view illustrating a liquid crystal display according to the exemplary embodiment of FIG. 36.

### DETAILED DESCRIPTION OF CERTAIN INVENTIVE EMBODIMENTS

The present invention will be described more fully hereinafter with reference to the accompanying drawings, in which exemplary embodiments are shown and described. As those skilled in the art would realize, the described embodiments may be modified in various different ways, all without departing from the spirit or scope of the present invention. In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

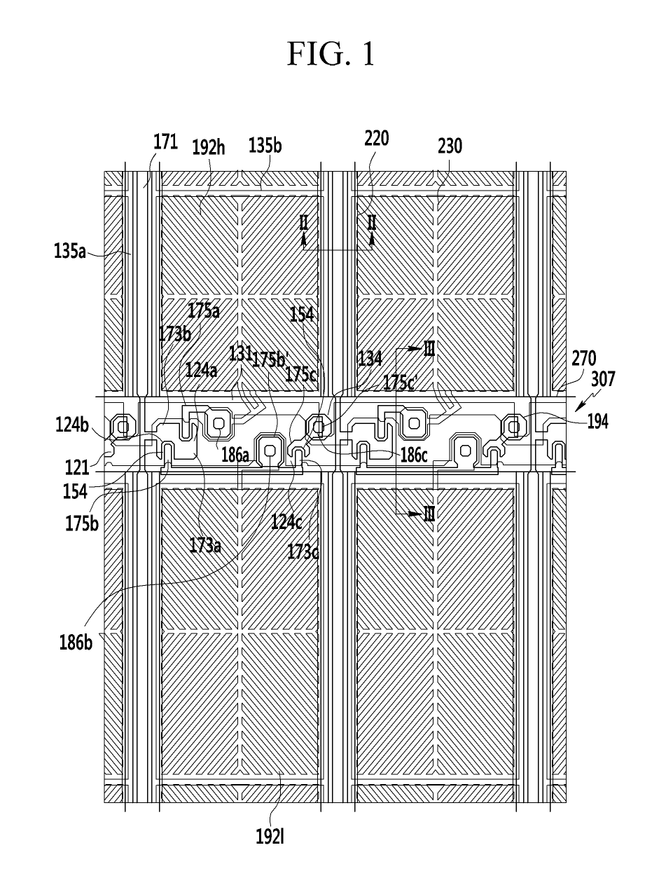

Now, a liquid crystal display according to an exemplary embodiment of the present disclosure will be described in detail with reference to FIGS. 1 to 3.

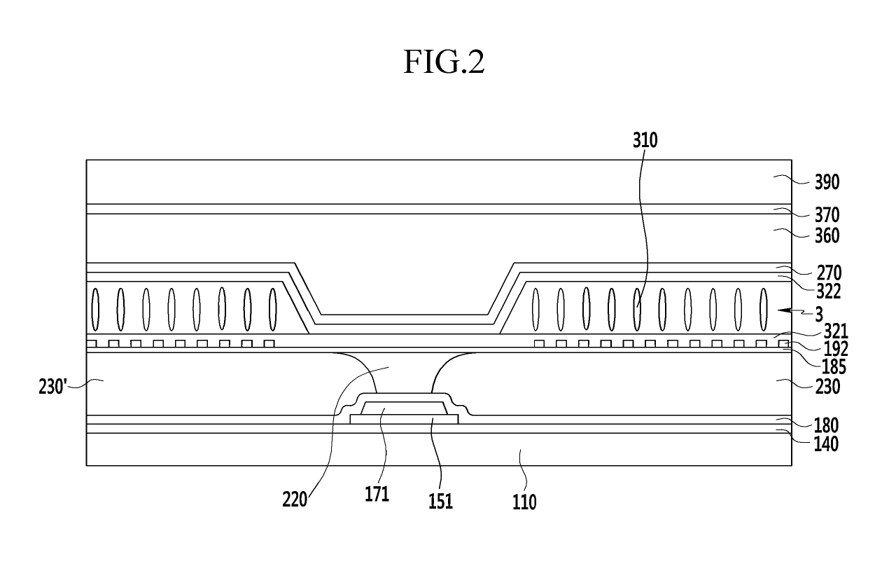

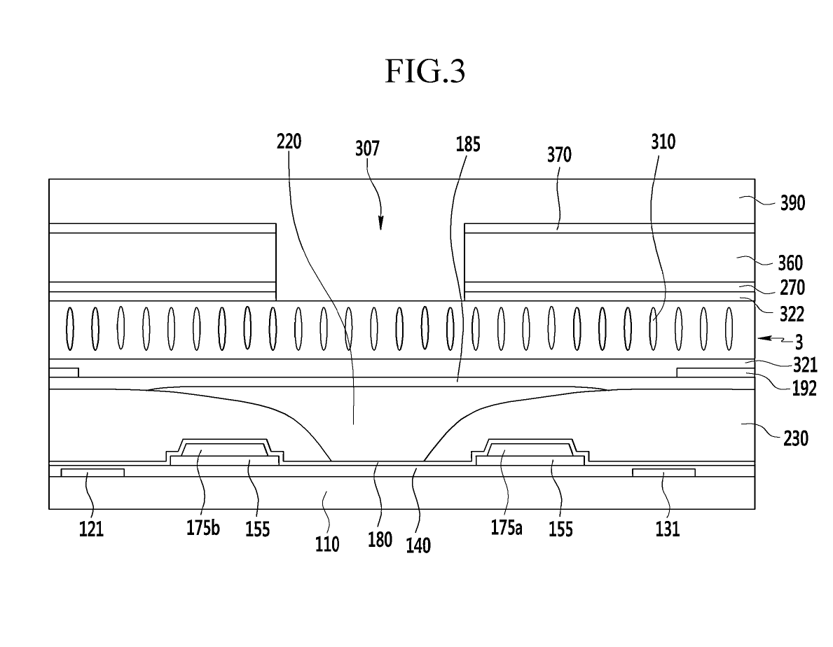

FIG. 1 is a layout view of a liquid crystal display according to an exemplary embodiment of the present disclosure, FIG. 2 is a cross-sectional view taken along the line II-II of FIG. 1, and FIG. 3 is a cross-sectional view taken along the line of FIG. 1.

A gate line 121 and a sustain voltage line 131 are formed on an insulation substrate 110 formed of a transparent glass or plastic. The gate line 121 includes a first gate electrode 124a, a second gate electrode 124b, and a third gate electrode 124c. The sustain voltage line 131 includes storage electrodes 135a and 135b and a protrusion 134 which protrudes toward the gate line 121. The storage electrodes 135a and 135b have a structure which encloses a first sub-pixel electrode 192h and a second sub-pixel electrode 192l of a previous row pixel. A horizontal portion of the storage electrode of FIG. 1 may be a wiring line that is not separated from a horizontal portion 135b of the previous row pixel.

A gate insulating layer 140 is formed on the gate line 121 and the sustain voltage line 131. On the gate insulating layer 140, a semiconductor 151 formed below the data line 171, a semiconductor 155 which is disposed below a source/drain electrode, and a semiconductor 154 formed in a channel portion of a thin film transistor are formed. On each of the semiconductors 151, 154, and 155 and between the data line 171 and the source/drain electrode, a plurality of ohmic contacts may be formed, which is not illustrated in the drawing.

On the semiconductors 151, 154, and 155 and the gate insulating layer 140, data conductors 171, 173c, 175a, 175b, 175c having a plurality of data lines 171, which has a first source electrode 173a and a second source electrode 173b, a first drain electrode 175a, a second drain electrode 175b, a third source electrode 173c and a third drain electrode 175c are formed.

The first gate electrode 124a, the first source electrode 173a, and the first drain electrode 175a form a first thin film transistor Qa together with the semiconductor 154 and a channel of the thin film transistor is formed in a semiconductor portion 154 between the first source electrode 173a and the first drain electrode 175a. Similarly, the second gate electrode 124b, the second source electrode 173b, and the second drain electrode 175b form a second thin film transistor Qb together with the semiconductor 154 and the channel of the thin film transistor is formed in the semiconductor portion 154 between the second source electrode 173b and the second drain electrode 175b. Further, the third gate electrode 124c, the third source electrode 173c, and the third drain electrode 175c form a third thin film transistor Qc together with the semiconductor 154 and the channel of the thin film transistor is formed in a semiconductor portion 154 between the third source electrode 173c and the third drain electrode 175c.

The data line 171 according to the present exemplary embodiment has a structure in which a width is reduced in a thin film transistor formation region near an extension 175c′ of the third drain electrode 175c. In some embodiments, the structure is intended to maintain a gap with an adjacent wiring line and reduce a signal interference, but the data line does not need to be formed with this structure.

A first passivation layer 180 is formed on the data conductors 171, 173c, 175a, 175b, and 175c and an exposed portion of the semiconductor 154. The first passivation layer 180 may include an inorganic insulator or an organic insulator such as silicon nitride (SiNx), silicon oxide (SiOx), silicon nitride oxide (SiOxNy), or silicon oxide (SiOx).

A color filter 230 is formed on the passivation layer 180. Color filters 230 having the same color are formed in pixels that are adjacent in a vertical direction (data line direction). Further, color filters 230 and 230′ having different colors are formed in pixels that are adjacent in a horizontal direction (gate line direction) and two color filters 230 and 230′ may overlap on the data line 171. The color filters 230 and 230′ may represent one of three primary colors including red, green, and blue. However, the color filters 230 and 230′ are not limited to the three primary colors including red, green, and blue but may represent one of cyan, magenta, yellow, and white series colors.

A light blocking member (black matrix) 220 is formed on the color filters 230 and 230′. The light blocking member 220 is formed with respect to a region (hereinafter, referred to as a “transistor formation region”) where the gate line 121, the sustain voltage line 131, and the thin film transistor are formed and a region where the data line 171 is formed and is formed to have a lattice structure having an opening corresponding to a region where an image is displayed. A color filter 230 is formed in an opening of the light blocking member 220. Further, the light blocking member 220 is formed of a material through which light is not transmitted.

A second passivation layer 185 is formed on the color filter 230 and the light blocking member 220 to cover the color filter 230 and the light blocking member 220. The second passivation layer 185 may include an inorganic insulator or an organic insulator such as silicon nitride (SiNx), silicon oxide (SiOx), silicon nitride oxide (SiOxNy), and silicon oxide (SiOx). Differently from the cross-sectional views of FIGS. 2 and 3, if a step portion occurs due to a difference in thicknesses of the color filter 230 and the light blocking member 220, the second passivation layer 185 includes an organic insulator to reduce or remove the step portion.

A first contact hole 186a and a second contact hole 186b are formed in the color filter 230, the light blocking member 220, and the passivation layers 180 and 185 to expose the extension 175b′ of the first drain electrode 175a and the second drain electrode 175b. Further, a third contact hole 186c is formed in the color filter 230, the light blocking member 220, and the passivation layers 180 and 185 to expose the protrusion 134 of the sustain voltage line 131 and the extension 175c′ of the third drain electrode 175c.

In the present exemplary embodiment, even though contact holes 186a, 186b, and 186c are also formed in the light blocking member 220 and the color filter 230, it may be more difficult to etch the contact hole in the light blocking member 220 and the color filter 230 than to etch the contact hole in the passivation layers 180 and 185 depending on a material of the light blocking member 220 and the color filter 230. Therefore, when the light blocking member 220 or the color filter 230 is etched, the light blocking member 220 or the color filter 230 may be removed in advance from a position where the contact holes 186a, 186b, and 186c are formed.

In some embodiments, depending on the exemplary embodiment, the position of the light blocking member 220 is varied to etch only the color filter 230 and the passivation layers 180 and 185 to form the contact holes 186a, 186b, and 186c.

The pixel electrode 192 which includes the first sub-pixel electrode 192h and the second sub-pixel electrode 192l is formed on the second passivation layer 185. The pixel electrode 192 may be formed of a transparent conductive material such as ITO or IZO.

The first sub-pixel electrode 192h and the second sub-pixel electrode 192l are adjacent in the column direction, formed in a quadrangular shape as a whole and include a cross-shaped branch including a horizontal branch and a vertical branch intersecting therewith. Further, the first sub-pixel electrode 192h and the second sub-pixel electrode 192l are divided into four sub-regions by the horizontal branch and the vertical branch and each sub-region includes a plurality of minute branches.

The minute branches of the first sub-pixel electrode 192h and the second sub-pixel electrode 192l form an angle of approximately 40° to 45° with the gate line 121 or the horizontal branch. Further, the minute branches of two neighboring sub-regions may be perpendicular to each other. The width of the minute branch may be gradually increased and gaps between minute branches may be varied.

The first sub-pixel electrode 192h and the second sub-pixel electrode 192l are physically and electrically connected to the first drain electrode 175a and the second drain electrode 175b through the contact holes 186a and 186b and are applied with data voltages from the first drain electrode 175a and the second drain electrode 175b.

In some embodiments, a connecting member 194 electrically connects the extension 175c′ of the third drain electrode 175c with the protrusion 134 of the sustain voltage line 131 through the third contact hole 186c. As a result, a part of the data voltage applied to the second drain electrode 175b is divided by the third source electrode 173c so the voltage applied to the second sub-pixel electrode 192l may be lower than the voltage applied to the first sub-pixel electrode 192h.

Here, an area of the second sub-pixel electrode 192l may be one time or more and two times or less of the area of the first sub-pixel electrode 192h.

In some embodiments, in the second passivation layer 185, an opening in which gas discharged from the color filter 230 is collected and a cover which is formed of the same material as the pixel electrode 192 on the opening to cover the opening may be formed. The opening and the cover are components which prevent the gas discharged from the color filter 230 from being transmitted to other elements and may not be essential components.

A lower alignment layer 321 may be formed on the second passivation layer 185 and the pixel electrode 192. The lower alignment layer 321 is an inorganic alignment layer containing an inorganic insulating material and uses silicon oxide (SiOx) in the present exemplary embodiment. Silicon oxide (SiOx) which has various chemical formulas in accordance with a composition ratio of oxygen in silicon oxide (SiOx) may be used. The lower alignment layer 321 formed from silicon oxide (SiOx) may not be formed on a pad unit (not illustrated), which is formed outside the lower insulation substrate to apply a signal to the gate line 121 and the data line 171 through the pad unit.

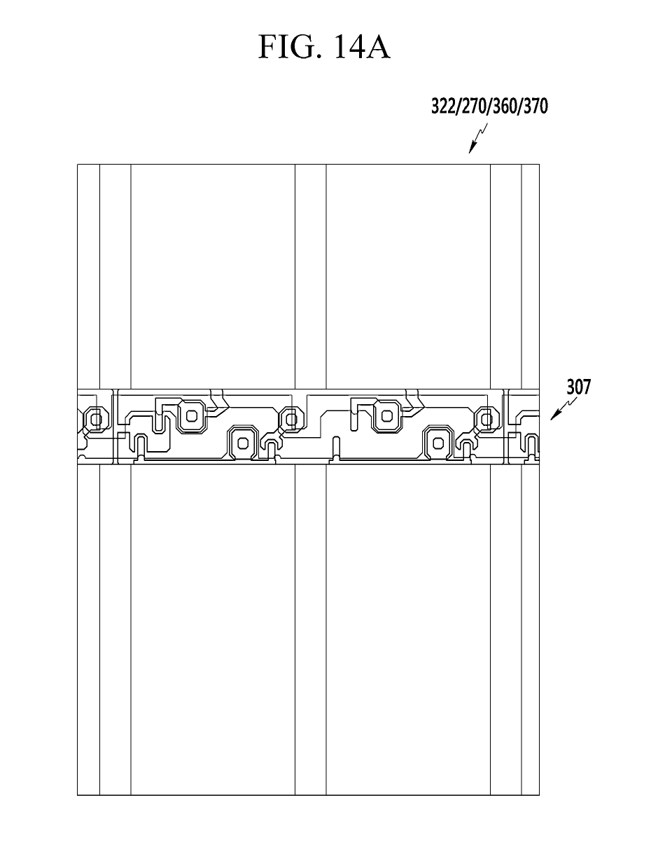

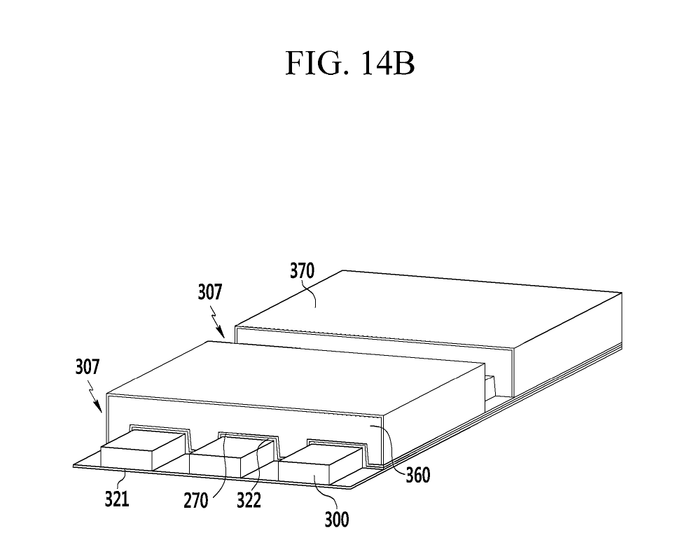

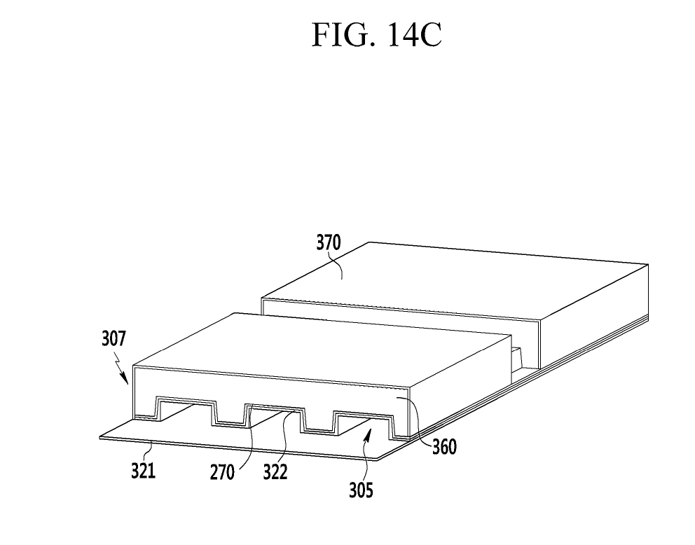

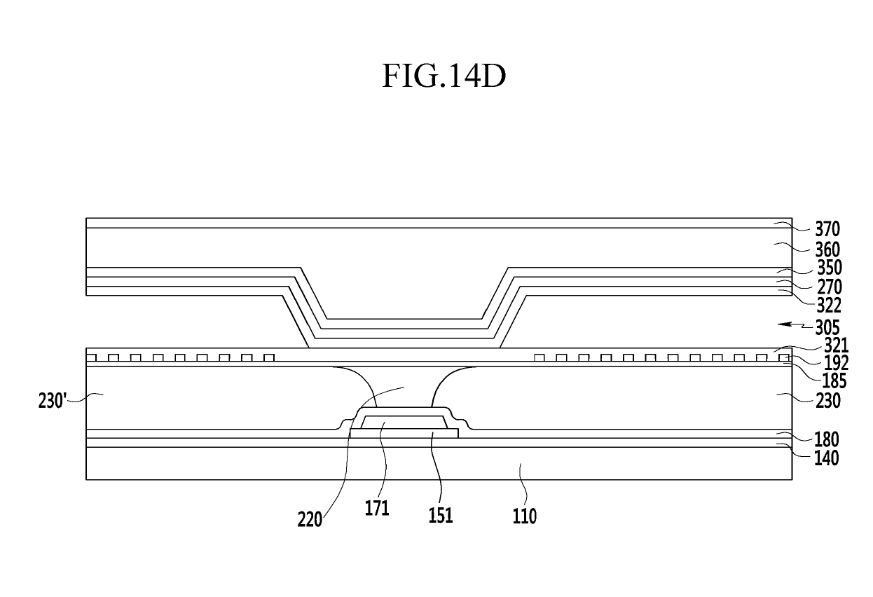

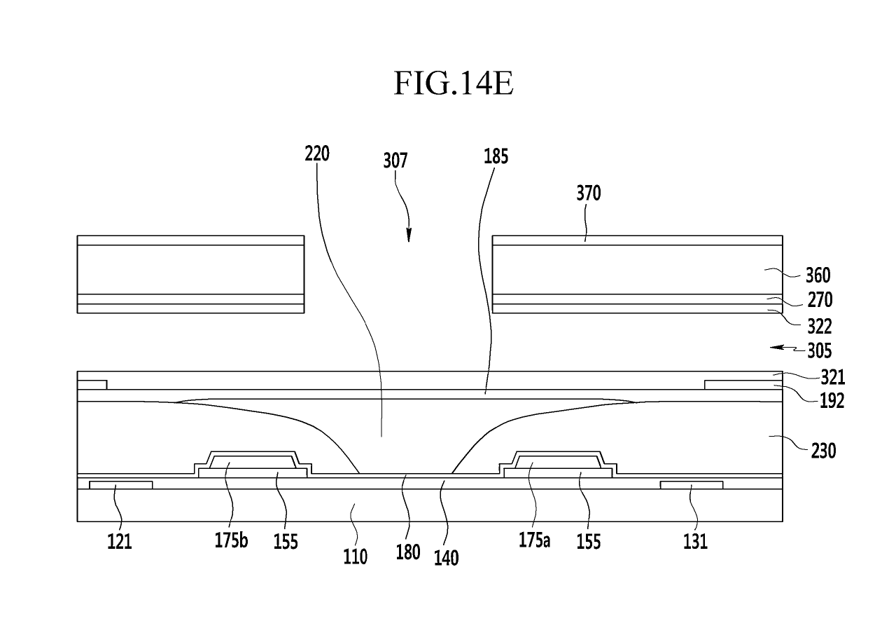

Microcavities 305 (see FIG. 14C, FIG. 14D and FIG. 14E) are formed on the lower alignment layer 321 which is the inorganic alignment layer. The liquid crystal layer 3 is formed in the microcavity 305.

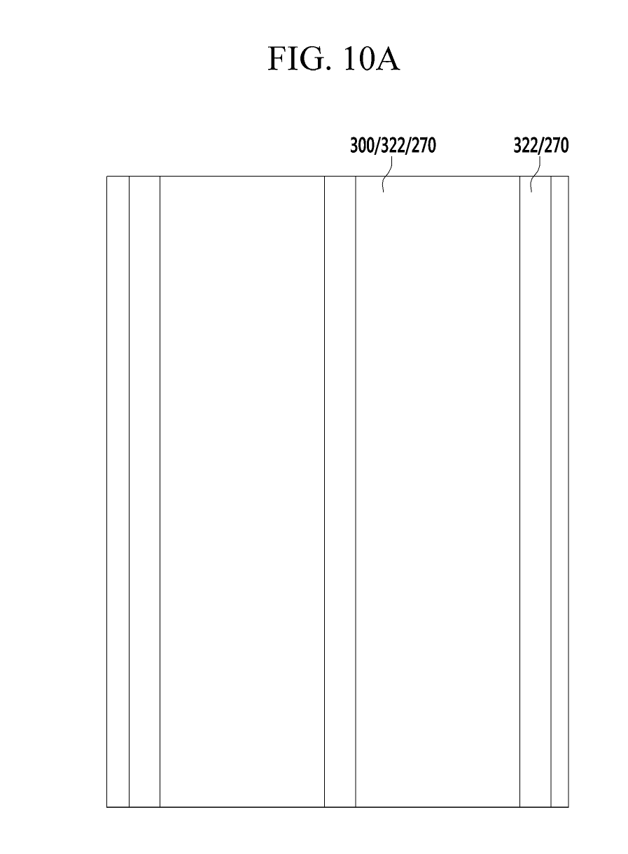

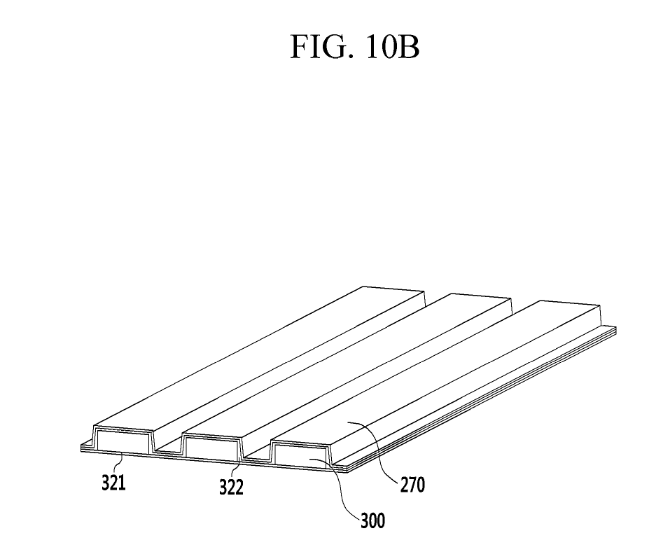

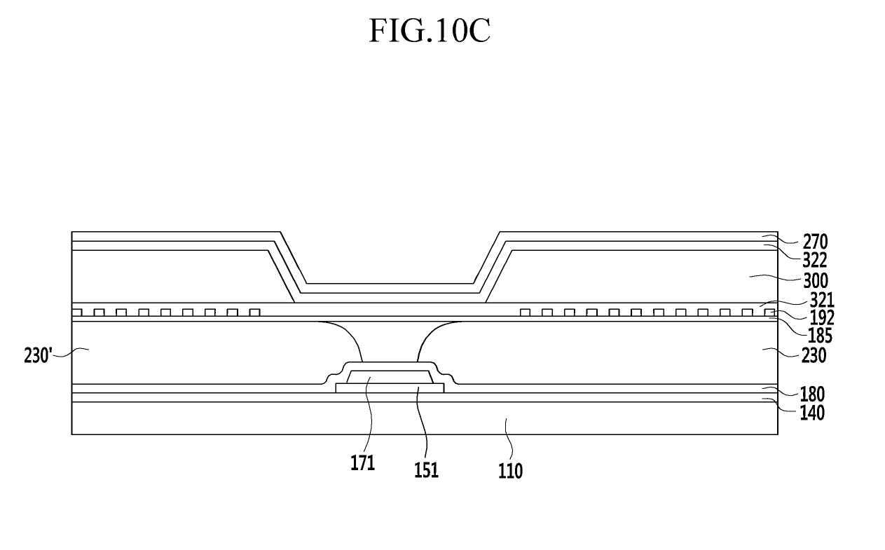

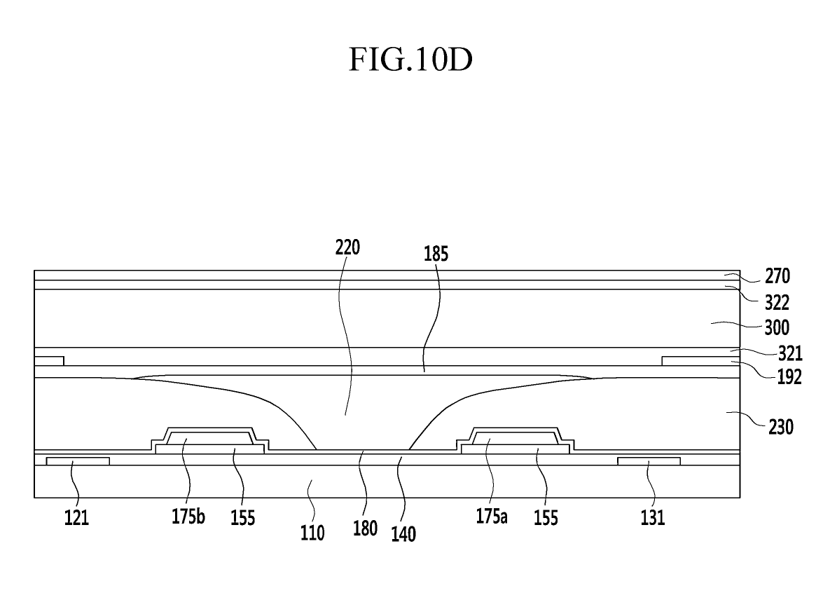

A top surface of the microcavity 305 has a horizontal plane and a side of the microcavity 305 is tapered. The microcavity 305 is a space generated when the sacrificial layer 300 (see FIG. 10) is formed and then removed and an upper alignment layer 322 is formed above and at a side of the microcavity 305.

Similarly to the lower alignment layer 321, the upper alignment layer 322 is also an inorganic alignment layer containing an inorganic insulating material and uses silicon oxide (SiOx) in the present exemplary. Silicon oxide (SiOx) which has various chemical formulas in accordance with a composition ratio of oxygen in silicon oxide (SiOx) may be used.

Referring to FIG. 2, in the present exemplary embodiment, the lower alignment layer 321 and the upper alignment layer 322 may be disposed in a location where the microcavity 305 is not formed, which is not around the liquid crystal layer 3 disposed in the microcavity 305. That is, a portion where the lower alignment layer 321 is in contact with the upper alignment layer 322 may be present between the microcavity 305 and the liquid crystal layer 3. In this portion, in some exemplary embodiments, the lower alignment layer 321 and the upper alignment layer 322 may not be formed.

A plurality of upper alignment layers 322 is divided with respect to a region 307 (hereinafter, referred to as a “liquid crystal injection hole formation region”) where a liquid crystal injection hole is formed to be formed to be spaced apart from each other. The liquid crystal injection hole formation region 307 is formed in a direction parallel to the gate line 121 and an extension direction of the upper alignment layer 322 is the same as an extension direction of the gate line 121.

As illustrated in the cross-sectional view of FIG. 2, the microcavity 305 is enclosed by the lower alignment layer 321 and the upper alignment layer 322. That is, a lower surface of the microcavity 305 is in contact with the lower alignment layer 321, and an upper surface and a side of the microcavity 305 are in contact with the upper alignment layer 322. In some embodiments, a front surface and a rear surface of the microcavity 305 are open to configure a liquid crystal injection hole. As described above, the microcavity 305 may be enclosed by the lower alignment layer 321 and the upper alignment layer 322 so that the liquid crystal molecules 310 of the liquid crystal layer 3 disposed in the microcavity 305 are aligned in accordance with an initial arrangement direction by the lower alignment layer 321 and the upper alignment layer 322. The lower alignment layer 321 and the upper alignment layer 322 are inorganic alignment layers and use silicon oxide (SiOx) in the present exemplary embodiment.

The liquid crystal layer 3 formed in the microcavity 305 is also referred to as a nano crystal. The liquid crystal layer 3 formed in the microcavity 305 may be injected in the microcavity 305 using a capillary force.

A common electrode 270 is disposed on the upper alignment layer 322. The common electrode 270 is formed along a curve of the upper alignment layer 322. A plurality of common electrodes 270 is divided with respect to the liquid crystal injection hole formation region 307 to be formed to be spaced apart from each other. The liquid crystal injection hole formation region 307 is formed in a direction parallel to the gate line 121 and an extension direction of the common electrode 270 is the same as an extension direction of the gate line 121.

The common electrode 270 is formed of a transparent conductive material such as ITO or IZO and generates an electric field together with the pixel electrode 192 to control an arrangement direction of the liquid crystal molecules 310.

A supporting member is formed on the common electrode 270. The supporting member according to the exemplary embodiment of the present disclosure includes a roof layer 360 and an upper insulating layer 370. In some exemplary embodiments, the upper insulating layer 370 may be omitted and the upper insulating layer 370 protects the roof layer 360.

The roof layer 360 is formed on the common electrode 270. The roof layer 360 may support so the microcavity is formed between the pixel electrode 192 and the common electrode 270. The roof layer 360 includes a pillar disposed in the upper portion of the liquid crystal layer 3 and a space between the liquid crystal layers 3. The liquid crystal layer 3 and the microcavity 305 are supported by the pillar of the roof layer 360 to be maintained. The roof layer 360 may be formed of a photo resist and other various organic materials.

The upper insulating layer 370 is formed on the roof layer 360. The upper insulating layer 370 may include an inorganic insulating material such as silicon nitride (SiNx), silicon oxide (SiOx), or silicon nitride oxide (SiOxNy).

A liquid crystal injection hole formation region 307 may be formed in one side of the roof layer 360 and the upper insulating layer 370 to inject the liquid crystal in the microcavity 305. The liquid crystal injection hole formation region 307 includes liquid crystal injection holes which are connected to each microcavity 305. The liquid crystal injection hole is an inlet through which the liquid crystal is injected in the microcavity 305. Further, the liquid crystal injection hole formation region 307 and the liquid crystal injection hole may be used to remove the sacrificial layer to form the microcavity 305.

A capping layer 390 is formed on the upper insulating layer 370 to seal the liquid crystal injection hole formation region 307. The capping layer 390 closes the liquid crystal injection hole formation region 307 and prevents the liquid crystal molecules 310 from flowing outside. The capping layer 390 is, as illustrated in FIGS. 2 and 3, formed on the entire region of the display device and may be formed only above or around the liquid crystal injection hole formation region 307 in some exemplary embodiments. The upper surface on which the capping layer 390 is formed may form a horizontal plane with the lower surface of the insulation substrate 110.

A polarizer (not illustrated) is disposed below the insulation substrate 110 and above the capping layer 390. The polarizer may include a polarizing element which generates polarization and a TAC (tri-acetyl-cellulose) layer which secures durability and in some exemplary embodiments, an upper polarizer and a lower polarizer may have transmissive axes which are vertical or parallel to each other.

In some embodiments, in FIGS. 2 and 3, the lower alignment layer 321 and the upper alignment layer 322 not only enclose the liquid crystal layer 3, but also are formed in other regions. That is, the lower alignment layer 321 and the upper alignment layer 322 are also formed in a region between the liquid crystal layers 3 and in some exemplary embodiment, at least one of the lower alignment layer 321 and the upper alignment layer 322 may be omitted in a region excepting a location which encloses the liquid crystal layer 3.

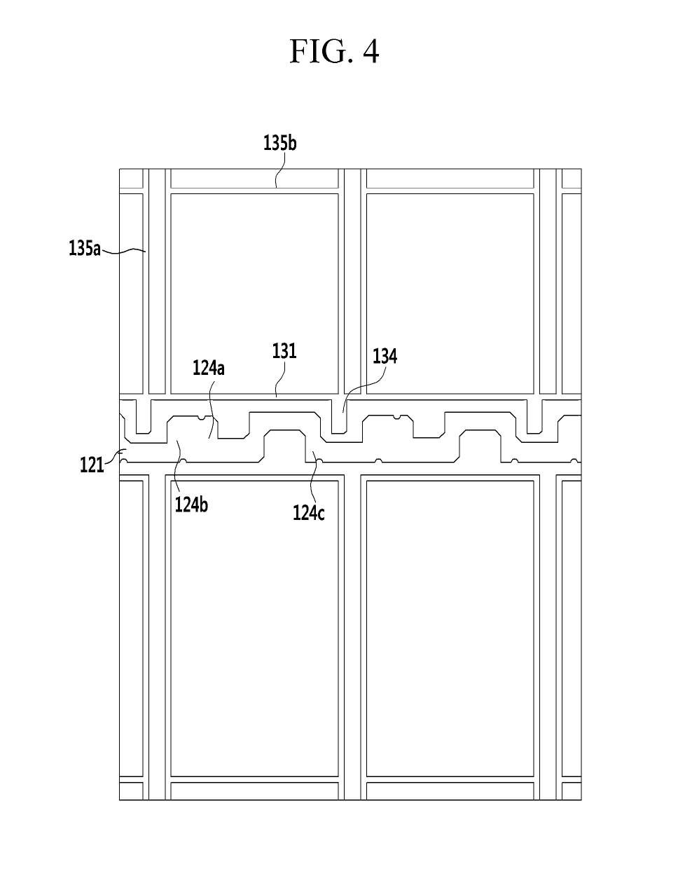

Hereinafter, a manufacturing method of a liquid crystal display according to an exemplary embodiment of the present disclosure will be described with reference to FIGS. 4 to 14. FIGS. 4 to 14 are diagrams sequentially illustrating a manufacturing method of a liquid crystal display according to an exemplary embodiment of FIGS. 1 to 3.

First, FIG. 4 is a layout view in which the gate line 121 and the sustain voltage line 131 are formed on the insulation substrate 110. Referring to FIG. 4, the gate line 121 and the sustain voltage line 131 are formed on the insulation substrate 110 formed of a transparent glass or plastic. The gate line 121 and the sustain voltage line 131 may be formed of the same material with the same mask. Further, the gate line 121 includes the first gate electrode 124a, the second gate electrode 124b, and the third gate electrode 124c and the sustain voltage line 131 includes the storage electrodes 135a and 135b and a protrusion 134 which protrudes toward the gate line 121. The storage electrodes 135a and 135b have a structure which encloses the first sub-pixel electrode 192h and the second sub-pixel electrode 192l of a previous row pixel. During operation, a gate voltage may be applied to the gate line 121 and a sustain voltage may be applied to the sustain voltage line 131 so that the gate line 121 and the sustain voltage line 131 are formed so as to be separated from each other. The sustain voltage may have a constant voltage level or a swinging voltage level. A gate insulating layer 140 may be formed on the gate line 121 and the sustain voltage line 131 to cover the gate line 121 and the sustain voltage line 131.

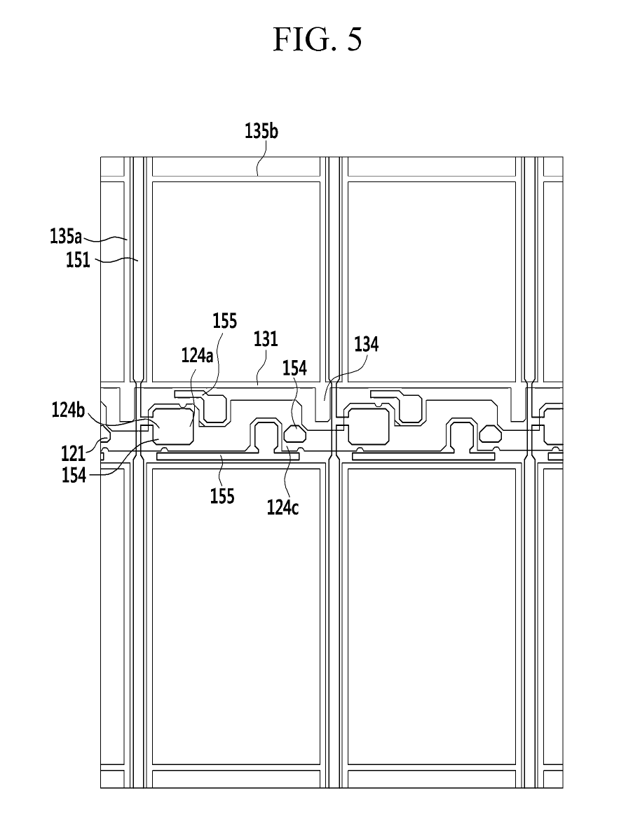

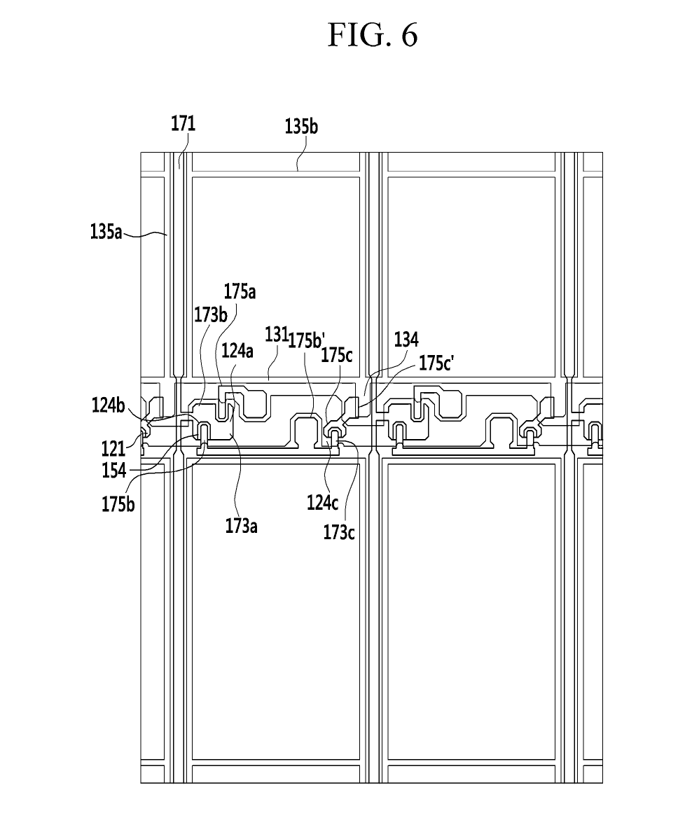

Thereafter, as illustrated in FIGS. 5 and 6, on the gate insulating layer 140, semiconductors 151, 154, and 155, a data line 171, and source/drain electrodes 173a, 173b, 173c, 175a, 175b, and 175c are formed.

FIG. 5 is a layout view in which the semiconductors 151, 154, and 155 are formed, and FIG. 6 is a layout view in which the data line 171 and the source/drain electrodes 173a, 173b, 173c, 175a, 175b, and 175c are formed. However, actually, the semiconductors 151, 154, and 155, the data line 171, and the source/drain electrodes 173a, 173b, 173c, 175a, 175b, 175c may be simultaneously formed by the following processes.

That is, a material for forming the semiconductor and the material for forming the data line/source/drain electrode are sequentially deposited. Thereafter, two patterns are simultaneously formed by one process of exposing, developing, and etching using one mask (slit mask or transflective mask). In this case, the semiconductor 154 which is positioned in a channel portion of the thin film transistor is exposed through a slit or transflective region of the mask so as not to be etched. In this case, a plurality of ohmic contacts may be formed on the semiconductors 151, 154, and 155 and between the data line 171 and the source/drain electrode.

The first passivation layer 180 is formed in the entire region of the data conductors 171, 173c, 175a, 175b, and 175c and the exposed portion of the semiconductor 154. The first passivation layer 180 may include an inorganic insulator or an organic insulator such as silicon nitride (SiNx), silicon oxide (SiOx), silicon nitride oxide (SiOxNy), or silicon oxide (SiOx).

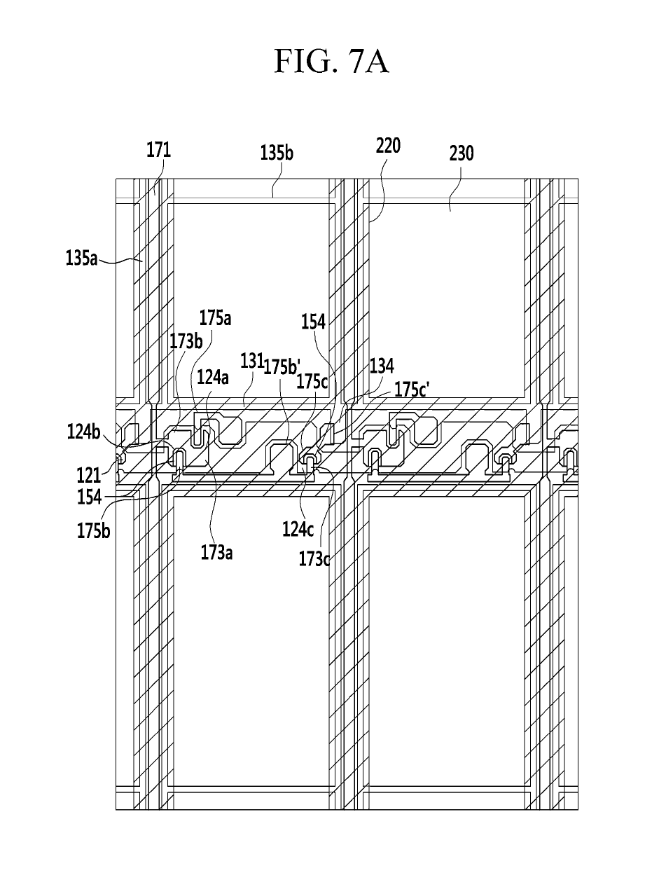

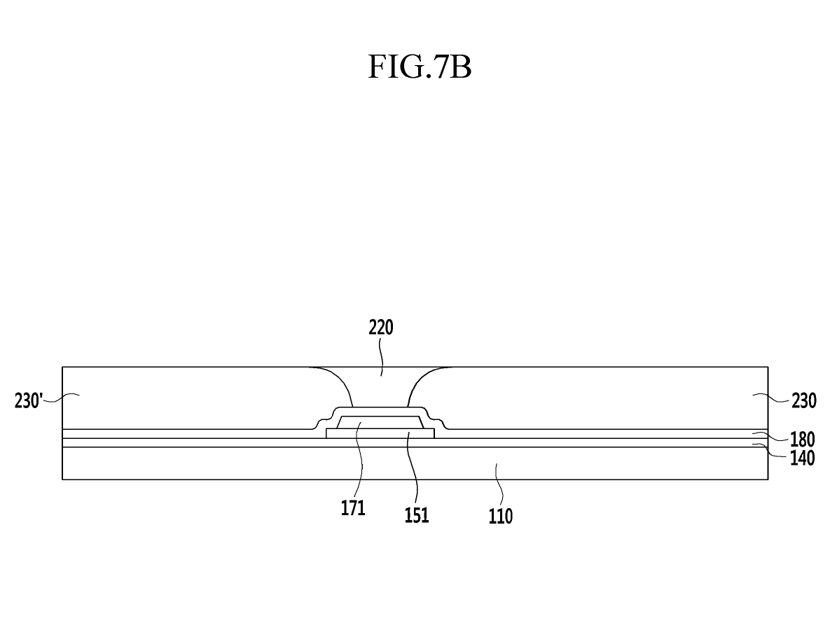

Thereafter, as illustrated in FIGS. 7A and 7B, the color filter 230 and the light blocking member (black matrix) 220 are formed on the first passivation layer 180. Here, FIG. 7A is a layout view corresponding to FIG. 1 and FIG. 7B is a cross-sectional view corresponding to FIG. 2. FIG. 7B illustrates the color filter 230 and the light blocking member 220 which are formed after the exposure process and the etching process.

When the color filter 230 and the light blocking member 220 are formed, the color filter 230 is formed first. The color filter 230 with one color is formed to be long in a vertical direction (data line direction) and the color filters 230 and 230′ with different colors are formed in adjacent pixels in the horizontal direction (gate line direction). As a result, the exposure process, the development process, and the etching process are performed for every color filter 230 with different colors. The liquid crystal display having three primary colors forms the color filters 230 by performing the exposure process, the development process, and the etching process three times. In this case, on the data line 171, a color filter 230′ which is performed earlier is disposed below a color filter 230 which is formed later so as to overlap each other.

When the color filter 230 is etched, the color filter 230 may be removed in advance from the locations where the contact holes 186a, 186b, and 186c are formed.

The light blocking member 220 is formed of a material through which light is not transmitted, on the color filter 230. Referring to a slant portion (indicating the light blocking member 220) of FIG. 7A, the light blocking member 220 has a lattice structure having an opening corresponding to a region where an image is displayed. The color filter 230 is formed in the opening. As illustrated in FIG. 7A, the light blocking member 220 includes a portion formed in a horizontal direction along the transistor formation region in which the gate line 121, the sustain voltage line 131, and the thin film transistor are formed and a portion which is formed in the vertical direction with respect to a region where the data line 171 is formed.

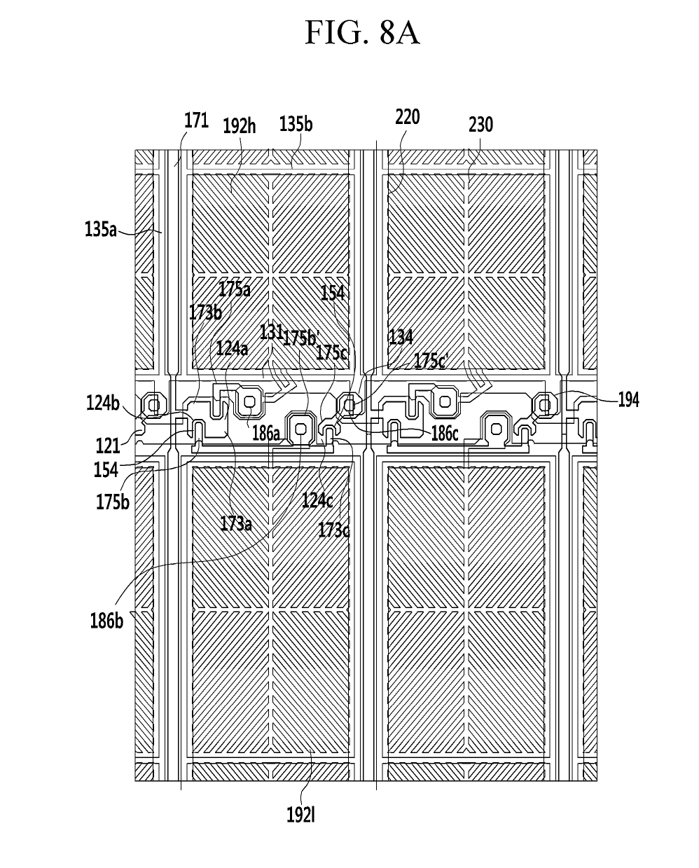

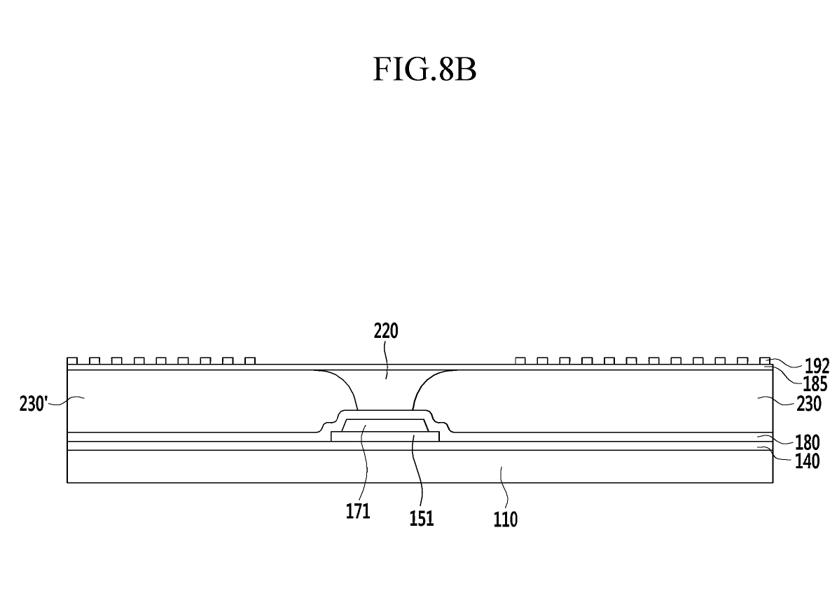

Referring to FIGS. 8A and 8B, a second passivation layer 185 is formed on the entire region of the color filter 230 and the light blocking member 220. The second passivation layer 185 may include an inorganic insulator or an organic insulator such as silicon nitride (SiNx), silicon oxide (SiOx), silicon nitride oxide (SiOxNy), or silicon oxide (SiOx).

Thereafter, a first contact hole 186a and a second contact hole 186b are formed in the color filter 230, the light blocking member 220 and the passivation layers 180 and 185 to expose the first drain electrode 175a and the extension 175b′ of the second drain electrode 175b. Further, a third contact hole 186c is formed in the color filter 230, the light blocking member 220 and the passivation layers 180 and 185 to expose the protrusion 134 of the sustain voltage line 131 and the extension 175c′ of the third drain electrode 175c.

Thereafter, the pixel electrode 192 which includes the first sub-pixel electrode 192h and the second sub-pixel electrode 192l is formed on the second passivation layer 185. In this case, the pixel electrode 192 may be formed of the transparent conductive material such as ITO or IZO. The first sub-pixel electrode 192h and the second sub-pixel electrode 192l are physically and electrically connected to the first drain electrode 175a and the second drain electrode 175b through the contact holes 186a and 186b. Further, a connecting member 194 which electrically connects the extension 175c′ of the third drain electrode 175c with the protrusion 134 of the sustain voltage line 131 through the third contact hole 186c is formed. As a result, a part of the data voltage applied to the second drain electrode 175b is divided by the third source electrode 173c so the voltage applied to the second sub-pixel electrode 192l may be lower than the voltage which is applied to the first sub-pixel electrode 192h.

Here, FIG. 8B corresponds to FIG. 2 and illustrates a cross-sectional view of the liquid crystal display formed through FIG. 8A.

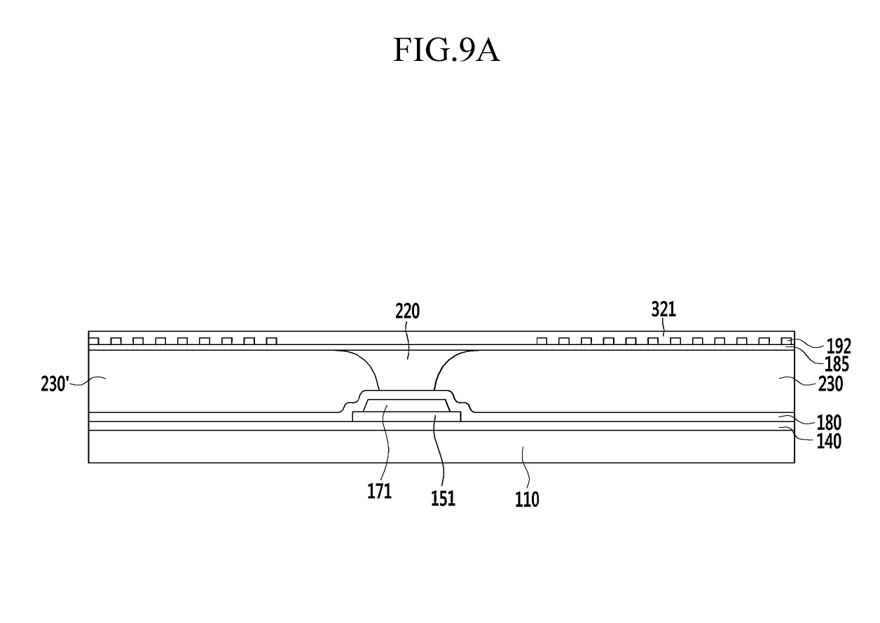

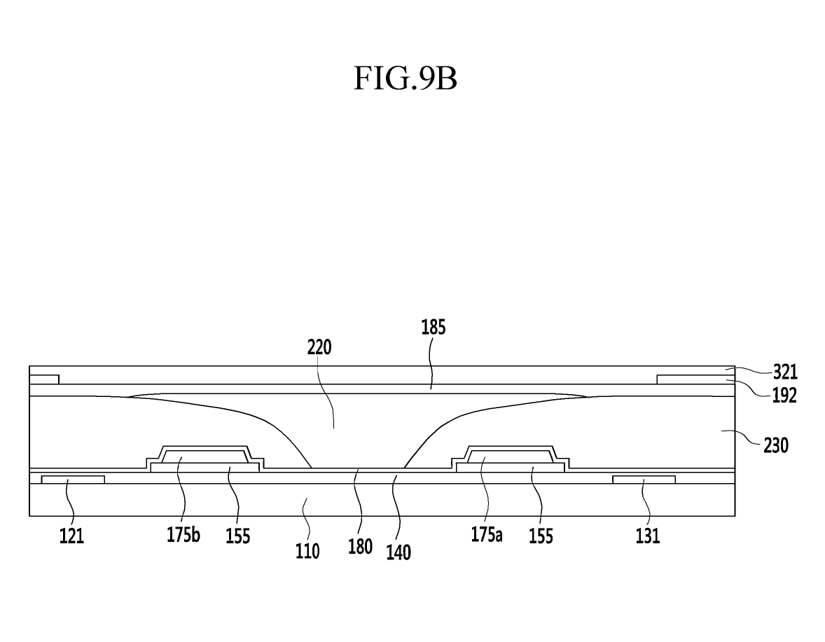

Thereafter, as illustrated in FIGS. 9A and 9B, a lower alignment layer 321 which covers the pixel electrode 192 is formed. The lower alignment layer 321 is an inorganic alignment layer containing an inorganic insulating material and uses silicon oxide (SiOx) in the present exemplary embodiment. Silicon oxide (SiOx) which has various chemical formulas in accordance with a composition ratio of oxygen in silicon oxide (SiOx) may be used. The inorganic alignment layer may be formed on an entire surface and then the inorganic alignment layer on the pad unit may be removed to complete the lower alignment layer 321 so as not to form the lower alignment layer 321 which is formed of silicon oxide (SiOx) on the pad unit (not illustrated) which is formed outside the lower insulation substrate.

Thereafter, as illustrated in FIGS. 10A to 10D, after forming the sacrificial layer 300, the upper alignment layer 322 and the common electrode 270 are sequentially formed thereon.

First, a process of forming the sacrificial layer 300 will be described. An organic layer such as a photo resist which is a material for the sacrificial layer is deposited on the entire surface of the liquid crystal panel on which the lower alignment layer 321 is formed. Thereafter, the deposited material for the sacrificial layer is patterned to form a structure of the sacrificial layer 300. When an organic layer such as a photo resist is used, the sacrificial layer 300 may be formed by the exposure process and in some exemplary embodiments, may be formed by a separate etching process.

The sacrificial layer 300 extends along the extending direction of the data line 171 to be formed long along the adjacent pixels in a vertical direction. The sacrificial layer 300 is not formed above the data line 171 and adjacent sacrificial layers 300 are spaced apart from each other with a predetermined interval. Further, the sacrificial layer 300 has the same structure as the microcavity 305 which will be formed later. A top surface of the sacrificial layer 300 has a horizontal plane and a side of the sacrificial layer 300 is tapered.

The upper alignment layer 322 is formed on the top surface and a horizontal plane of the sacrificial layer 300 and between the sacrificial layers 300. Similarly to the lower alignment layer 321, the upper alignment layer 322 is an inorganic alignment layer containing an inorganic insulating material and uses silicon oxide (SiOx) in the present exemplary. Silicon oxide (SiOx) which has various chemical formulas in accordance with a composition ratio of oxygen in silicon oxide (SiOx) may be used. A transparent conductive material may be deposited on the upper alignment layer 322 to form the common electrode 270.

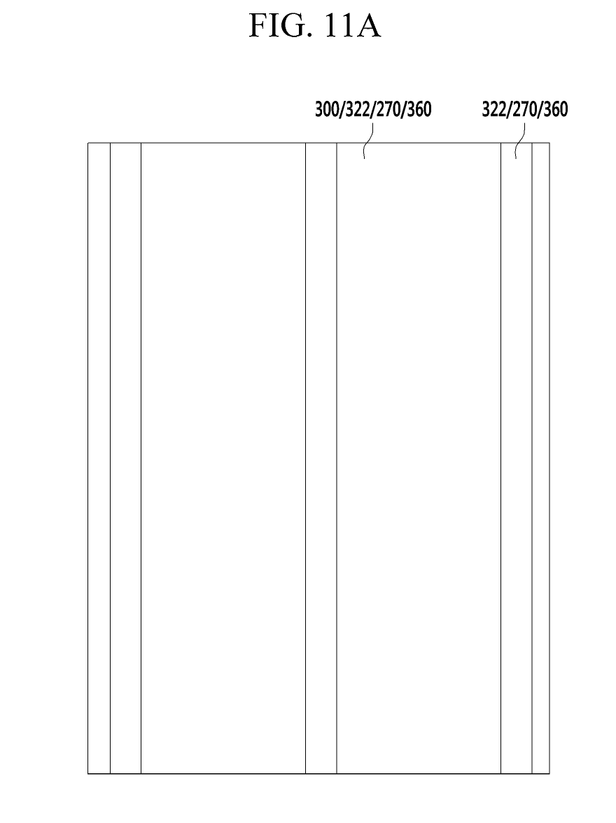

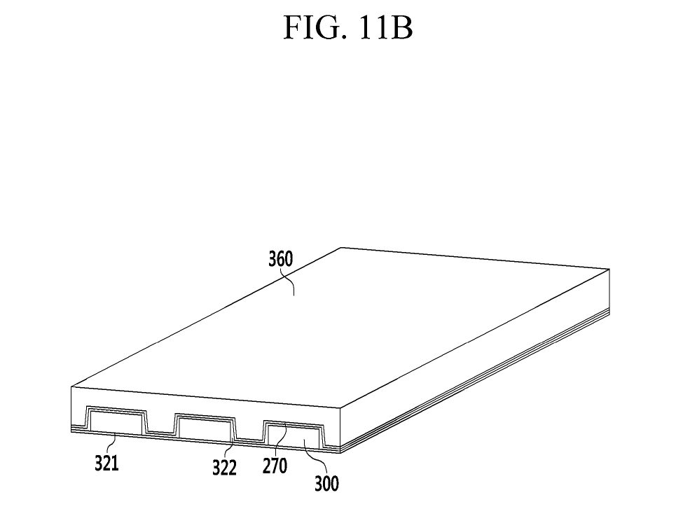

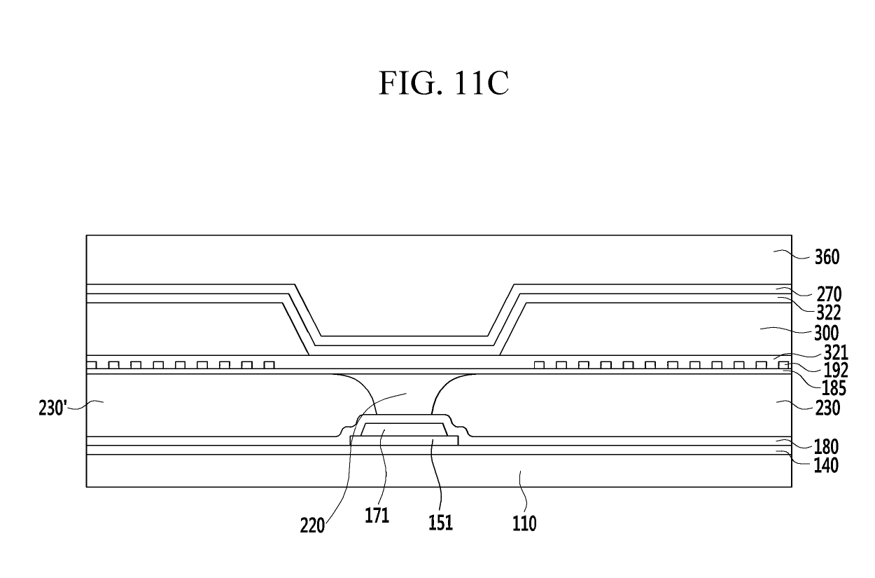

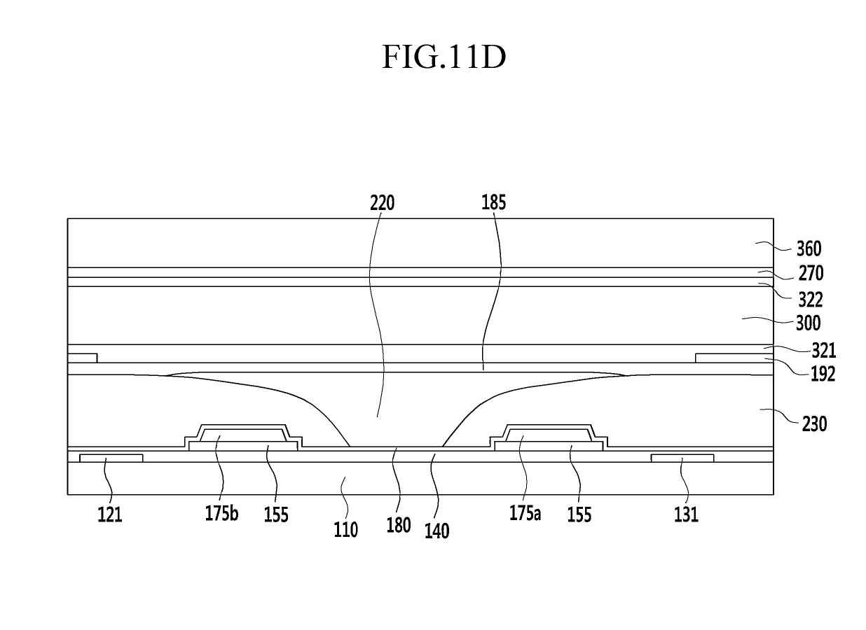

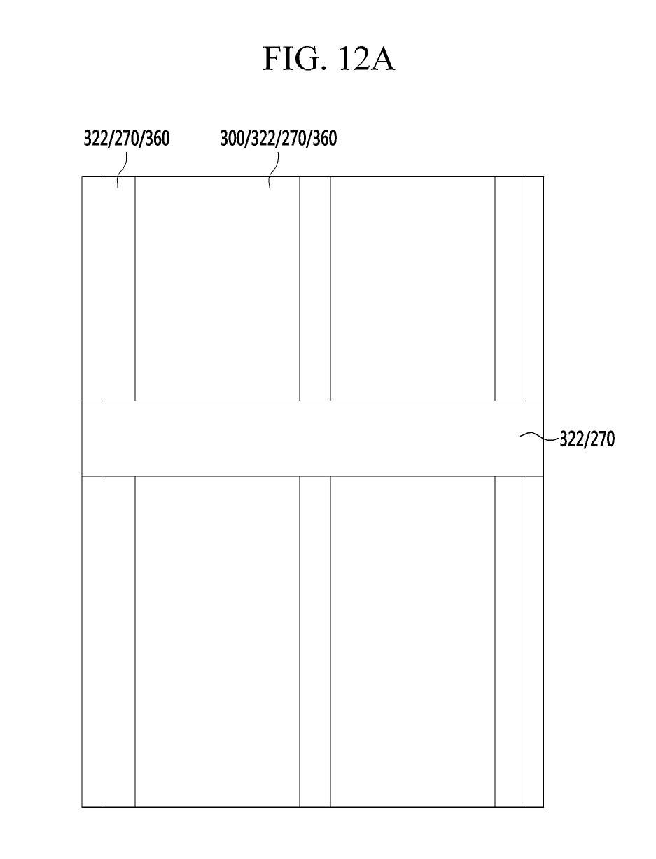

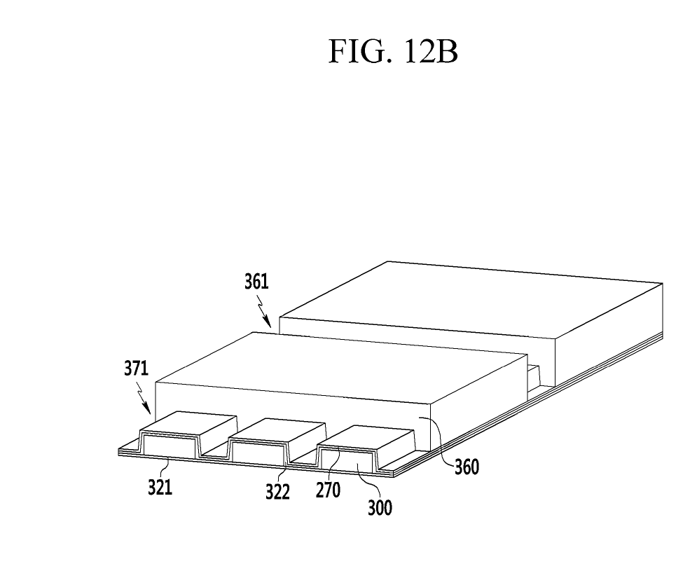

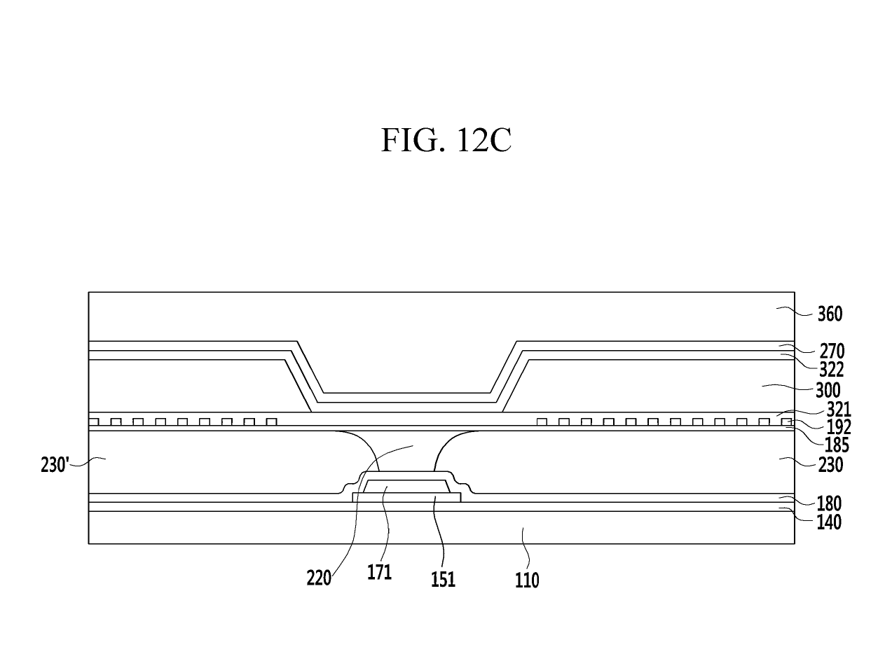

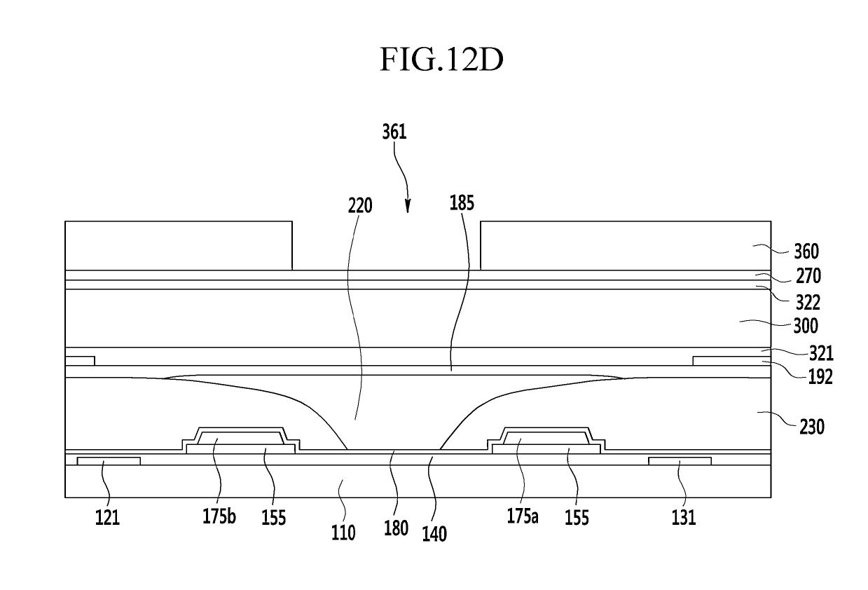

Thereafter, as illustrated in FIGS. 11A to 11D, the organic material is deposited on the common electrode 270 to form the roof layer 360. The deposited roof layer 360 in FIGS. 11A to 11D is deposited over entire region. However, the roof layer 360 according to the present exemplary embodiment has a structure where a part of the common electrode 270 is exposed through the opening 360 as illustrated in FIGS. 12A to 12D. That is, the organic material such as a photo resist is deposited as illustrated in FIGS. 11A to 11D and then exposed and developed to form the opening 361 to expose the common electrode 270 below the organic material. The opening 361 corresponds to the liquid crystal injection hole formation region 307.

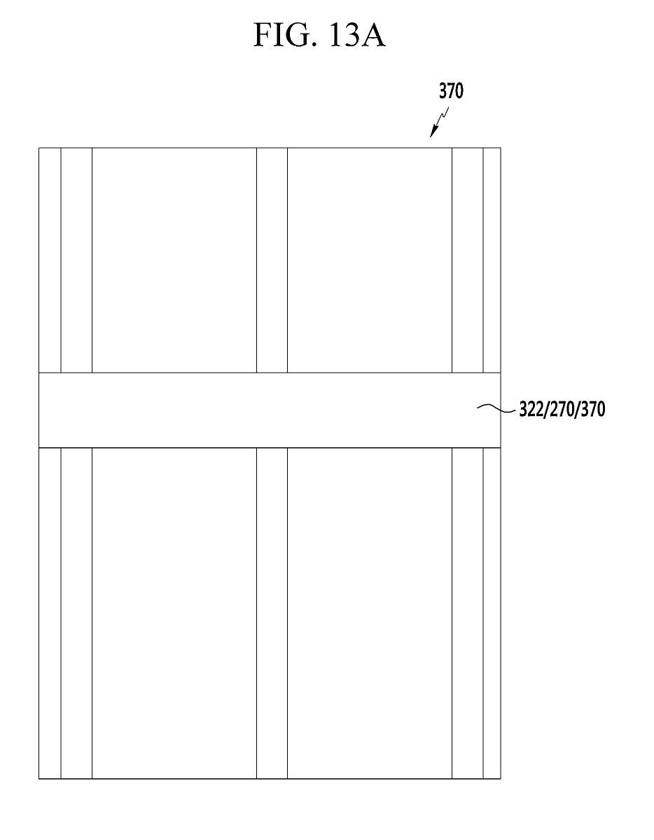

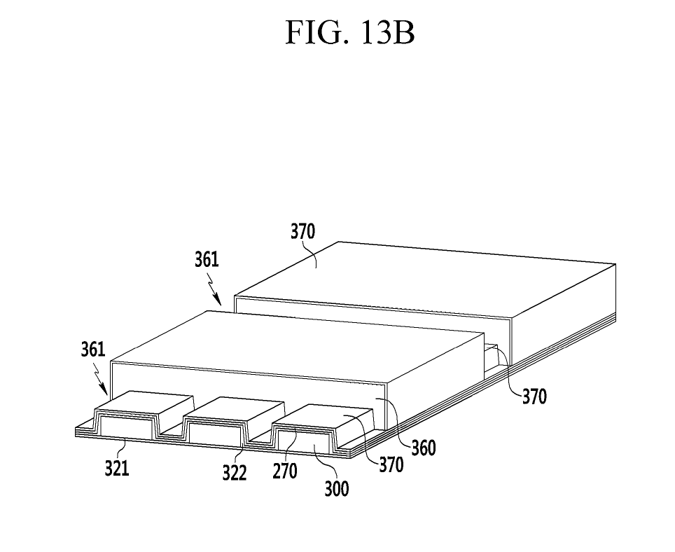

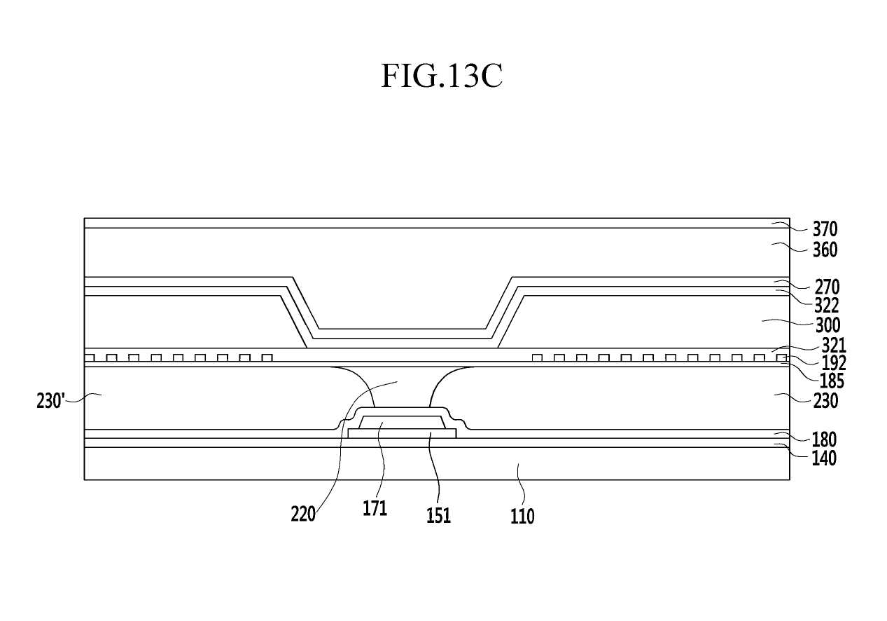

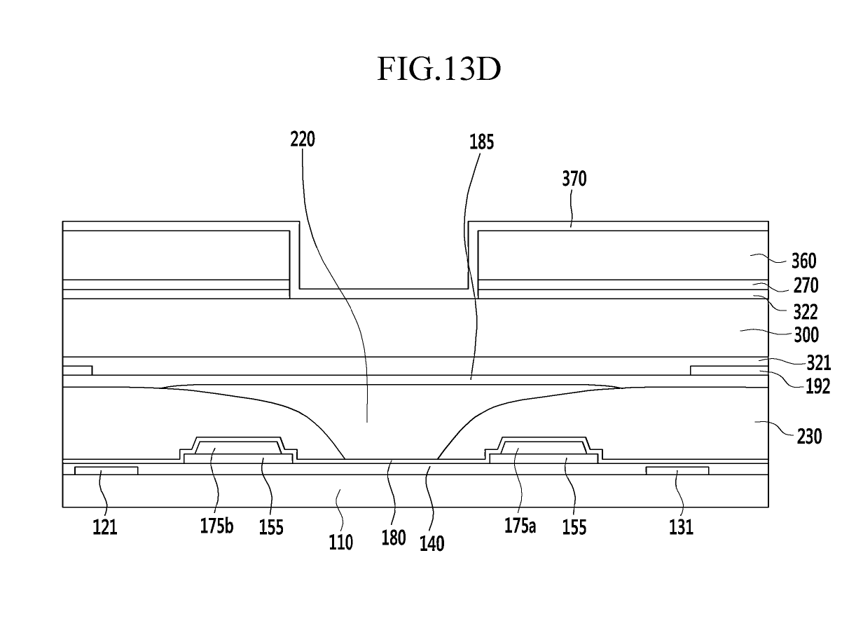

Thereafter, as illustrated in FIGS. 13A to 13D, a material for the upper insulating layer containing an inorganic insulating material such as silicon nitride (SiNx), silicon oxide (SiOx), or silicon nitride oxide (SiOxNy) is deposited to form the upper insulating layer 370 on the entire surface of the liquid crystal panel.

The upper insulating layer 370 is formed not only on the roof layer 360, but also directly on the common electrode 270 in the opening 361 in which the roof layer 360 is not formed.

Thereafter, as illustrated in FIGS. 14A to 14E, the liquid crystal injection hole formation region 307 is etched to expose the sacrificial layer 300 and then the sacrificial layer 300 is removed to form the microcavity 305.

More specifically, as illustrated in FIG. 14B, of the upper insulating layer 370 w deposited on the entire region of the display panel with an inorganic insulating material such as silicon nitride (SiNx), silicon oxide (SiOx), or silicon nitride oxide (SiOxNy), the upper insulating layer 370 formed in the liquid crystal injection hole formation region 307, is dry-etched to expose the common electrode 270. Thereafter, the common electrode 270 formed in the liquid crystal injection hole formation region 307 is wet-etched to expose the upper alignment layer 322. Thereafter, the upper alignment layer 322 formed in the liquid crystal injection hole formation region 307 is dry-etched to expose the sacrificial layer 300.

In some exemplary embodiments, the upper insulating layer 370, the common electrode 270 and the upper alignment layer 322 may be etched by the same etching process.

In order to etch the liquid crystal injection hole formation region 307, the photo resist PR is formed on the entire region and the photo resist PR corresponding to the liquid crystal injection hole formation region 307 may be removed to form a photo resist pattern, and then the lower layers are etched along the photo resist pattern to etch the liquid crystal injection hole formation region 307. In this case, as the layer in the liquid crystal injection hole formation region 307 which is etched, the material 370 for the upper insulating layer, the common electrode 270, and the upper alignment layer 322 are etched but the layer below the etched layer is not etched. In some exemplary embodiments, only a part of the sacrificial layer 300 is etched or none of the sacrificial layer 300 is etched. Here, the process of etching the liquid crystal injection hole formation region may be a dry etching process and if there is an etching solution which etches the layer to be etched, a wet etching process may be used.

Thereafter, as illustrated in FIGS. 14C to 14E, the exposed sacrificial layer 300 is removed. In the present exemplary embodiment, the sacrificial layer 300 may be removed using a photo resist pattern which etches the liquid crystal injection hole formation region 307 and a photo resist stripper.

Thereafter, as illustrated in FIGS. 2 and 3, the liquid crystal layer 3 may be injected in the microcavity 305 using the capillary force.

Thereafter, to prevent the liquid crystal layer 3 injected in the microcavity 305 leaking to the outside, a process of forming a capping layer 390 to seal the microcavity 305 may be performed.

In some exemplary embodiments, the upper insulating layer 370 may be omitted.

Further, a process of attaching a polarizer (not illustrated) may be further performed above the lower and upper insulating layers 370 of the insulation substrate 110. The polarizer may include a polarizing element which generates polarization and a TAC (tri-acetyl-cellulose) layer which secures durability and in some exemplary embodiments, an upper polarizer and a lower polarizer may have transmissive axes which are vertical or parallel to each other.

In the liquid crystal display manufactured as described above, the lower alignment layer 321 and the upper alignment layer 322 which enclose the microcavity 305 are formed of the inorganic alignment layer and in this exemplary embodiment of the present disclosure, silicon oxide (SiOx) is used. An example of the inorganic insulating material used as the inorganic alignment layer includes silicon nitride (SiNx), silicon carbide (SiCx), amorphous silicon (a-Si), or FDLC (fluorinated diamond-like carbon) in addition to silicon oxide (SiOx).

As described above, the alignment layer is formed using a process of depositing the insulating layer formed of the inorganic material so that the processing time is shortened as compared with the case where the alignment layer is injected in the microcavity and the alignment layer is uniformly distributed in the microcavity 305.

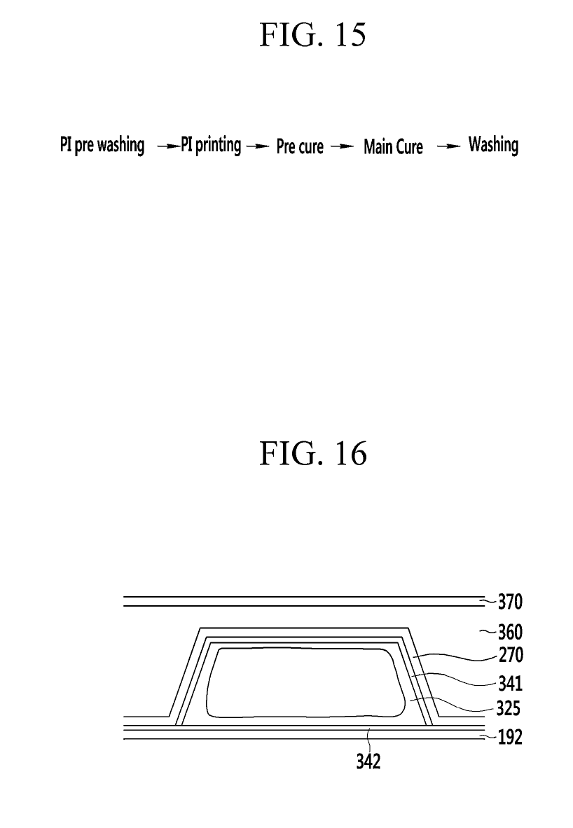

Hereinafter, a Comparative Example which injects the alignment layer will be described with reference to FIGS. 15 to 20 by comparing with the exemplary embodiment in which an inorganic alignment layer is formed are compared.

First, FIGS. 15 and 16 illustrate the Comparative Example which injects the alignment layer. FIG. 15 is a diagram illustrating a step of forming an alignment layer in the liquid crystal display according to a Comparative Example and FIG. 16 is a cross-sectional view illustrating an alignment layer actually formed in the liquid crystal display according to the Comparative Example.

In a step of forming the alignment layer in the Comparative Example, as illustrated in FIG. 15, a washing process is performed before injecting polyimide PI, and the polyimide PI is injected to be formed (or printed) in a position where the alignment layer is formed, and then curing is performed through a pre-cure step and a main cure step to finally perform the washing process and complete the alignment layer. However, the manufacturing time is significantly increased due to such multiple steps.

Further, as illustrated in FIG. 16, if the polyimide PI is injected in the microcavity, the polyimide is formed to be thin on the upper portion and to be thick on the lower portion due to the gravity. The thickness of the polyimide PI may be varied depending on the location. As a result, in the microcavity, an alignment force of the liquid crystal molecules may be varied in the microcavity depending on the location.

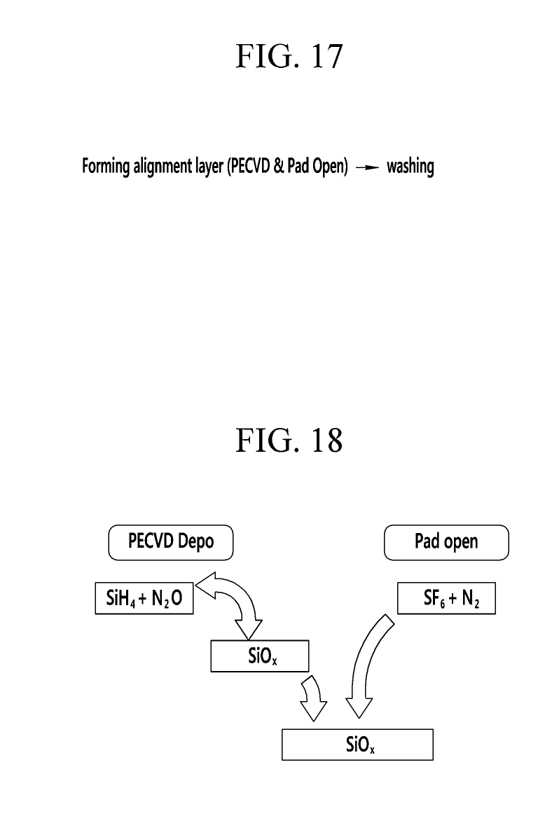

Additionally, in a display device such as a TV which is used for a long time, the display device may be heated to a high temperature so that the high temperature characteristic is an important factor. Therefore, in the Comparative Example which forms an alignment layer in the microcavity using polyimide PI, the high temperature long-term stability may have a problem. However, when the inorganic alignment layer is deposited as described in the exemplary embodiment of the present disclosure, the above problem may not arise, which will be described with reference to FIGS. 17 to 20.

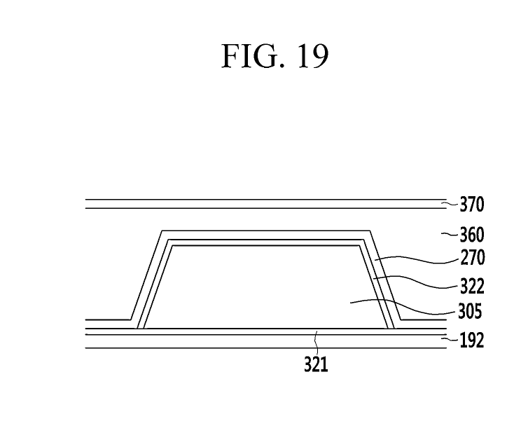

FIGS. 17 and 18 are diagrams illustrating a step of forming an alignment layer in the liquid crystal display according to the exemplary embodiment of the present disclosure, FIG. 19 is a cross-sectional view illustrating the alignment layer manufactured as illustrated in FIGS. 17 and 18, and FIG. 20 is a flowchart illustrating a manufacturing method of a liquid crystal display according to an exemplary embodiment of the present disclosure.

Referring to FIG. 17, if the inorganic alignment layer is formed as described in the exemplary embodiment of the present disclosure, the inorganic insulating layer is deposited to complete the inorganic alignment layer and then the alignment force of the liquid crystal molecules may be improved through the washing step. Some exemplary embodiments may further include a step of depositing the inorganic insulating layer and a step of removing the inorganic insulating layer formed on the pad to open the pad. The exemplary embodiment proceeds with total three steps including the pad opening step so that the number of steps is smaller than that of the Comparative Example of FIG. 15 and a step of injecting the liquid crystal layer in the microcavity and a curing step are unnecessary, and which may very shorten the manufacturing time. Further, as illustrated in FIGS. 1 to 14, the inorganic insulating layer may be formed while depositing and patterning other constituent elements so the processing time is significantly shortened. Further, high temperature long-term stability is improved.

Referring to FIG. 18, when silicon oxide (SiOx) is used to form an inorganic alignment layer, gases which are used when the inorganic alignment layer is deposited and the pad is open are illustrated.

According to the exemplary embodiment of FIG. 18, if SiH₄ gas and N₂O gas are used as source gases to provide plasma using a PECVD method, the source gases react to generate SiOx to be deposited on the substrate to form an inorganic alignment layer of silicon oxide (SiOx).

Thereafter, in order to open the pad portion, SF₆ and N₂ which are etching gases are used to etch the inorganic alignment layer on the pad.

The alignment layer, which is formed to enclose the microcavity using the inorganic alignment layer generated as described above may have a structure illustrated in FIG. 9.

When comparing FIG. 19 with FIG. 16, the inorganic alignment layer formed according to the exemplary embodiment of the present disclosure is more uniformly formed and has more uniform alignment force.

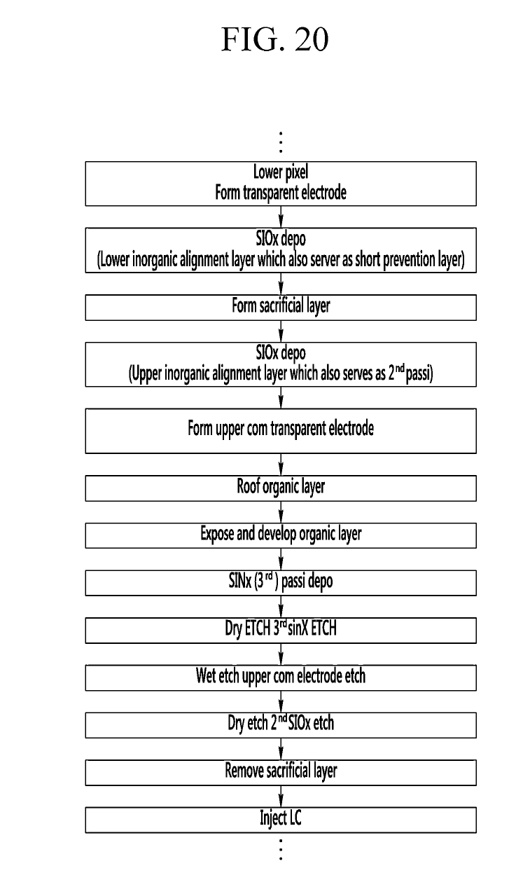

FIG. 20 illustrates a flowchart of each step of a process of forming the microcavity and the inorganic alignment layer in the manufacturing method of a liquid crystal display according to an exemplary embodiment of the present disclosure. Referring to FIG. 20, steps before forming the pixel electrode 192 are omitted.

After performing a step of forming a pixel electrode 192 (referred to as a lower pixel transparent electrode), the silicon oxide (SiOx) is deposited thereon to form the lower alignment layer 321. Here, the lower alignment layer 321 is an inorganic alignment layer and determines an alignment direction of the liquid crystal molecules 310 and is an insulating layer which covers the pixel electrode 192 and functions as a short prevention layer which prevents the pixel electrode 192 from being shorted from other wiring or electrodes. That is, according to the exemplary embodiment, in the liquid crystal display having a microcavity, the pixel electrode 192, and the common electrode 270 approach each other so a short prevention layer is formed on the pixel electrode 192 to prevent the pixel electrode 192 and the common electrode 270 from being shorted. Therefore, according to the exemplary embodiment of the present disclosure, the lower alignment layer 321 also functions as a short prevention layer so that a separate film does not need to be formed.

Thereafter, the sacrificial layer 300 is formed on the lower alignment layer 321. The sacrificial layer 300 corresponds to a microcavity 305 in which the liquid crystal layer 3 will be formed.

Thereafter, silicon oxide (SiOx) is deposited on the lower alignment layer 321 and the sacrificial layer 300 to form the upper alignment layer 322. Here, the upper alignment layer 322 is an inorganic alignment layer to determine an alignment direction of the liquid crystal molecule 310 and also serves as an insulating layer (a second passivation). This is because the inorganic insulating material is used rather than the polyimide PI and the material is used as the insulating layer in the liquid crystal display. Accordingly, in some exemplary embodiments, an additional insulating layer does not need to be formed.

The common electrode 270 (referred to as an upper com transparent electrode) is formed on the upper alignment layer 322 to cover the upper alignment layer 322.

The roof layer 360 is formed on the common electrode 270. To form the roof layer 360, an organic layer such as a photo resist is deposited, exposed, and developed to complete the roof layer 360 having an opening 361.

On the roof layer 360 and in the opening 361, silicon nitride (SiNx) is deposited on the upper insulating layer 370 (referred to as a 3rd passi).

Thereafter, the upper insulating layer 370, the common electrode 270 and the upper alignment layer 322 may be deposited in the opening 361 of the roof layer 360 are etched to form the liquid crystal injection hole formation region 307 and expose the sacrificial layer 300. Specifically, the upper insulating layer 370 may be deposited in the opening 361 of the roof layer 360 by dry-etching and then the common electrode 270 may be wet-etched. Thereafter, the upper alignment layer 322 is dry-etched to expose the sacrificial layer 300. The sacrificial layer 300 exposed by the liquid crystal injection hole formation region 307 is removed by the wet-etching process to form the microcavity 305 and the liquid crystal molecules 310 are injected in the microcavity 305 to complete the liquid crystal layer 3.

The manufacturing method according to the exemplary embodiment of FIG. 20 may be modified depending on the exemplary embodiment.

The inorganic alignment layer may be a vertical alignment layer or a horizontal alignment layer in accordance with the manufacturing process. That is, e-beam is irradiated after depositing the inorganic alignment layer to form the alignment direction. Therefore, the inorganic alignment layer may be a vertical alignment layer or a horizontal alignment layer depending on the e-beam irradiating direction.

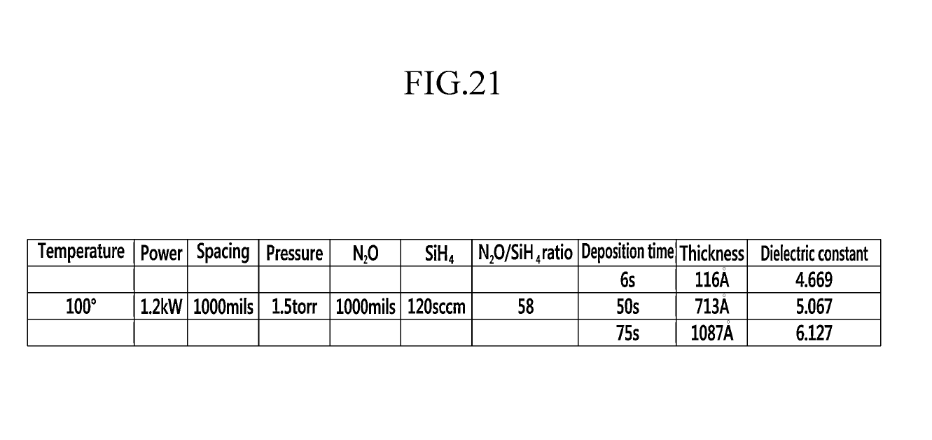

Hereinafter, with reference to FIGS. 21 to 35, a characteristic of the inorganic alignment layer will be described.

FIGS. 21 to 35 are diagrams illustrating a characteristic of an alignment layer according to an exemplary embodiment of the present disclosure.

First, FIG. 21 is a table which analyzes a correlation of a thickness of the inorganic alignment layer manufactured with the silicon oxide (SiOx) and a vertical alignment characteristic of the liquid crystal molecule.

The vertical alignment characteristic of the silicon oxide (SiOx) inorganic alignment layer is affected by a thickness of the alignment layer and a change in the thickness is evaluated as illustrated in FIG. 21 to improve the vertical alignment force by analyzing a difference in physical properties of the silicon oxide (SiOx) inorganic alignment layer in accordance with the thickness of the alignment layer.

During the process of forming the inorganic alignment layer, the vertical alignment characteristic is not showed in a 116 Å condition having a small thickness and the vertical alignment is formed in 713 Å and 1087 Å conditions having a large thickness. Therefore, as an expected result, the vertical alignment characteristic may be improved in accordance with an increase of the thickness of the inorganic alignment layer. As the experimental result, it is checked that the silicon oxide (SiOx) inorganic alignment layer needs to have a thickness of 400 Å or 1000 Å or between about 400 Å and 1000 Å to have the vertical alignment characteristic. In some embodiments, the thickness is about 400 Å, 500 Å, 600 Å, 700 Å, 800 Å, 900 Å, 1000 Å or any range therebetween.

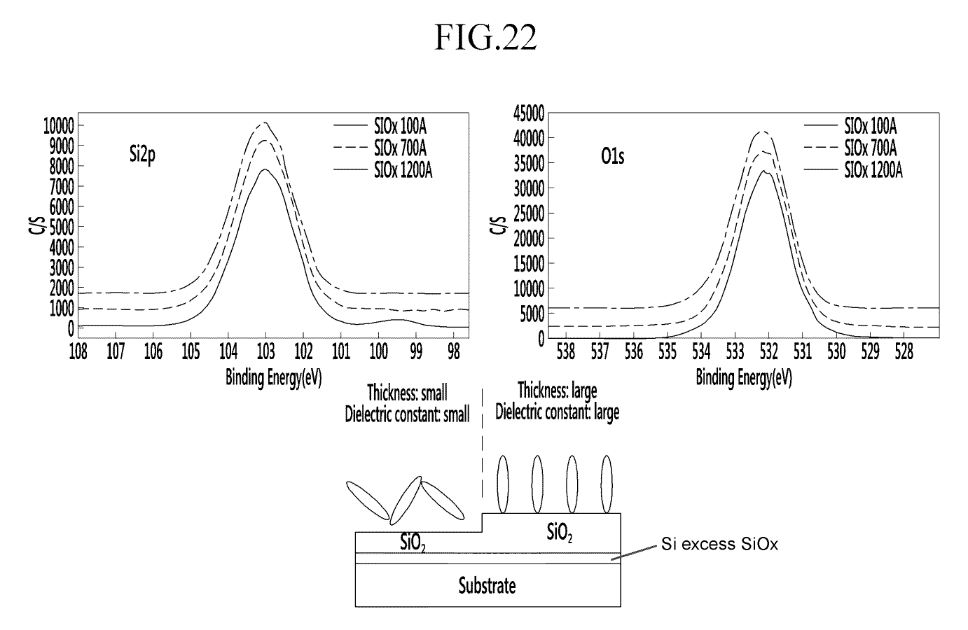

FIG. 22 illustrates a graph which analyzes a correlation between a thickness of the inorganic alignment layer and a composition of the inorganic alignment layer. In FIG. 22, a dielectric constant characteristic is analyzed to analyze a physical property in accordance with the change in the thickness of the silicon oxide (SiOx) inorganic alignment layer. As illustrated in a graph of a lower portion of FIG. 22, the dielectric constant tends to increase as the thickness of the inorganic alignment layer increases. That is, the dielectric constant is increased as the thickness of the inorganic alignment layer increases and the vertical alignment is formed in a condition of a high dielectric constant. When the thickness of the inorganic alignment layer is small, a silicon oxide (Si excess SiOx) alignment layer containing much silicon component is formed.

To verify a possibility that the dielectric constant is low, a composition of the SiOx alignment layer is verified by an XPS analysis and the result is illustrated in two graphs in the upper portion of FIG. 22. As illustrated in two graphs, regardless of the thickness of the inorganic alignment layer, a peak of 2p orbital of Si and a peak of 1 s orbital of O have the same shape. As a result, the composition of the silicon oxide (SiOx) inorganic alignment layer is present in a SiO2.3 to SiO2.4 region. That is, the composition of the silicon oxide (SiOx) inorganic alignment layer has a stoichiometric characteristic so that it is confirmed that the dielectric constant of the inorganic alignment layer may be changed by a composition of the inorganic alignment layer, that is, other factors rather than the silicon oxide (Si excess SiOx) in which a large amount of silicon component is contained.

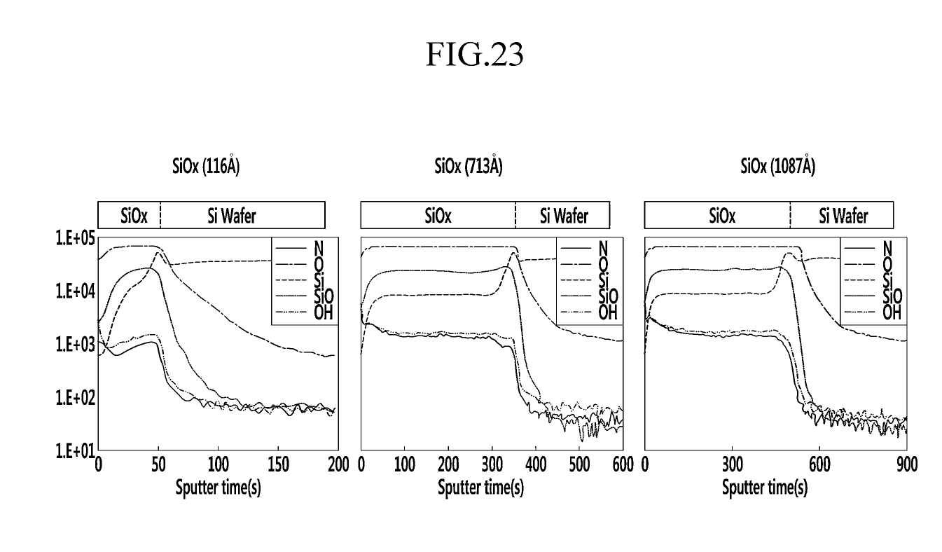

FIG. 23 illustrates a graph which analyzes a correlation between a thickness of the inorganic alignment layer of the silicon oxide (SiOx) and an OH concentration of the alignment layer.

To investigate a cause why the dielectric constant is increased as the thickness of the silicon oxide (SiOx) inorganic alignment layer increases, a graph obtained by measuring an OH concentration of the inorganic alignment layer by TOF-SIMS is illustrated in FIG. 23.

As illustrated in the graph of FIG. 23, the OH component is present in the entire region of the inorganic alignment layer regardless of the thickness of the inorganic alignment layer and an amount also increases as the thickness is increased.

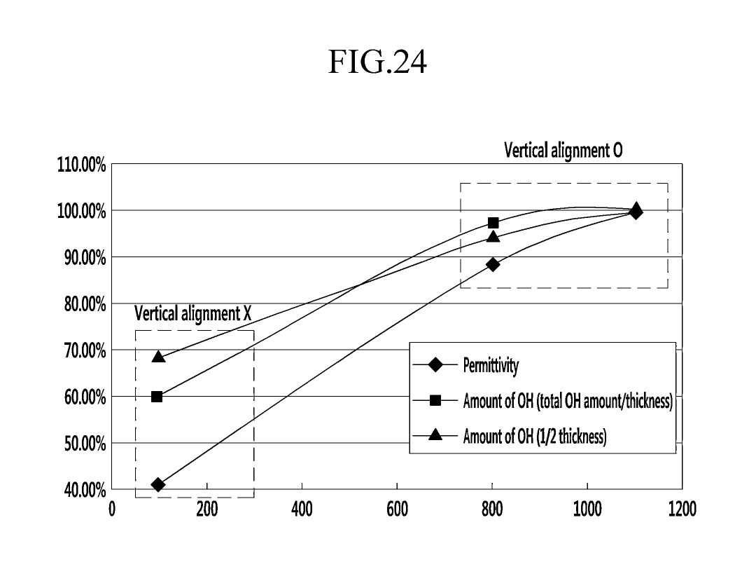

As described above, an interrelation of thickness/OH amount/dielectric constant/alignment characteristic of the inorganic alignment layer will be summarized as illustrated in FIG. 24.

As illustrated in FIG. 24, the dielectric constant of the inorganic alignment layer may be determined by the increase of the amount of the OH present in the inorganic alignment layer and an amount of OH per every unit thickness is increased as the thickness is increased. That is, as the time of maintaining the substrate in a deposition chamber is increased, an adsorption possibility of OH radical present in the deposition chamber is increased. Therefore, an amount of OH adsorbed per unit thickness is increased.

Therefore, a vertical alignment characteristic of the inorganic alignment layer may be adjusted by adjusting a thickness of the inorganic alignment layer and a change in the thickness of the inorganic alignment layer causes the change in the OH concentration in the inorganic alignment layer, and thus, a dielectric constant is adjusted. A dielectric constant of the silicon oxide (SiOx) inorganic alignment layer may be 5, 6, or 7 or between about 5 and about 7.

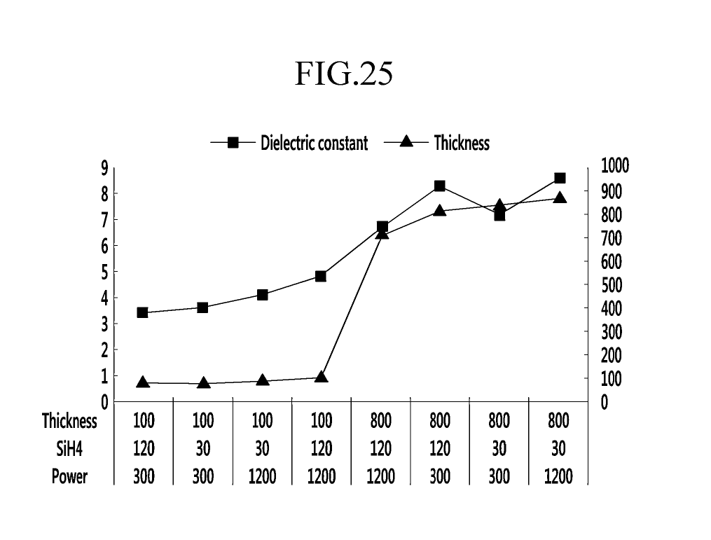

As described above, a main physical property factor which determines the vertical alignment characteristic of the inorganic alignment layer is the dielectric constant and a main process variable for adjusting the dielectric constant is a deposition time, that is, a deposition thickness. Additionally, to confirm a deposition process which can adjust the dielectric constant, as illustrated in FIG. 25, a power and a concentration of SiH₄ are adjusted at a constant thickness condition of the inorganic alignment layer to check whether the dielectric constant can be adjusted.

FIG. 25 illustrates a graph and a table of a power and a concentration of SiH₄ in accordance with the thickness of the inorganic alignment layer. As illustrated in FIG. 25, a characteristic of the dielectric constant is most largely changed by the thickness. Further, the dielectric constant is slightly changed by the change in the concentration of SiH₄ and the power. Furthermore, the thickness of the inorganic alignment layer and the dielectric constant do not have an exact proportional relationship in a condition of a predetermined thickness or larger and the dielectric constant is slightly changed by the power or a SiH₄ condition.

Therefore, the most main factor which adjusts the dielectric constant as the process condition is the inorganic alignment layer thickness, but the power or the amount of SiH₄ may slightly affect the change in the dielectric constant.

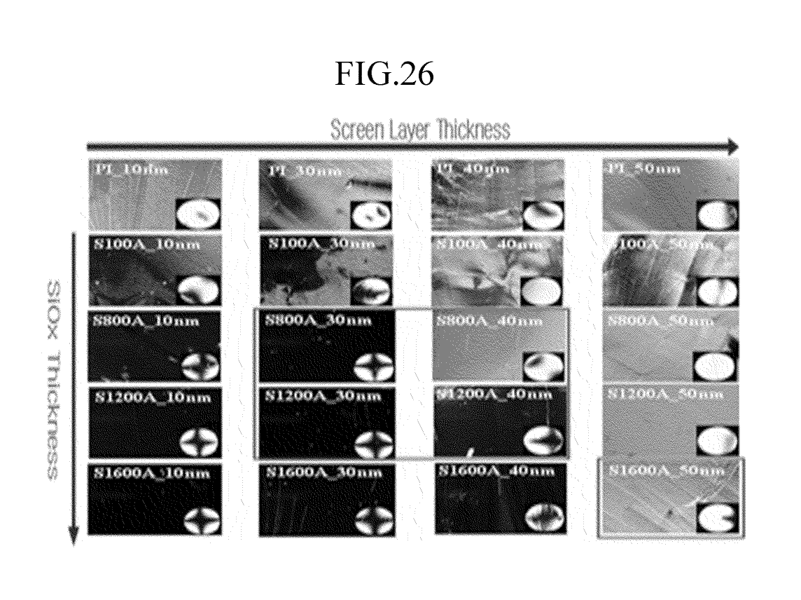

FIG. 26 illustrates an alignment force in accordance with a screen effect.

In some embodiments the inorganic alignment layer has a relatively thick alignment and dielectric constant characteristic to have an acceptable vertical alignment characteristic. However, the correlation between the alignment layer thickness and the dielectric constant, and the vertical alignment force is not investigated. Therefore, to investigate the correlation between the alignment layer thickness and the alignment force, as shown in FIG. 26, an FDLC (fluorinated diamond like carbon) is formed on a surface of the silicon oxide (SiOx) inorganic alignment layer and the thicknesses of the silicon oxide (SiOx) and the FDLC are varied to compare the liquid crystal alignment characteristics. Further, to compare with the polyimide PI alignment layer, the FDLC thin film is also formed on the surface of the polyimide PI alignment layer.

As illustrated in FIG. 26, when the thickness of the silicon oxide (SiOx) inorganic alignment layer is small and the thickness of the screen layer (FDLC) is large, the vertical alignment characteristic is deteriorated. Therefore, in the case of the silicon oxide (SiOx) inorganic alignment layer, it is understood that a vertical alignment is formed by a van der waals force and the vertical alignment force may be affected by the thickness of the silicon oxide (SiOx) inorganic alignment layer. Therefore, to improve the vertical alignment force, it is required to increase an OH content by increasing the thickness and secure the high dielectric constant characteristic. However, in the case of the polyimide PI alignment layer, the vertical alignment is not formed in all conditions, which is different from the silicon oxide (SiOx) inorganic alignment layer, so that relative comparison of vertical alignment force cannot be performed.

The liquid crystal alignment force in accordance with the thickness of the silicon oxide (SiOx) inorganic alignment layer can be compared by the screen effect, but the vertical alignment forces of the silicon oxide (SiOx) inorganic alignment layer and the polyimide PI alignment layer cannot be compared. Therefore, in order to relatively compare the alignment forces of the silicon oxide (SiOx) inorganic alignment layer and the polyimide (PI) alignment layer, a wedge cell is formed to relatively compare the liquid crystal alignment status.

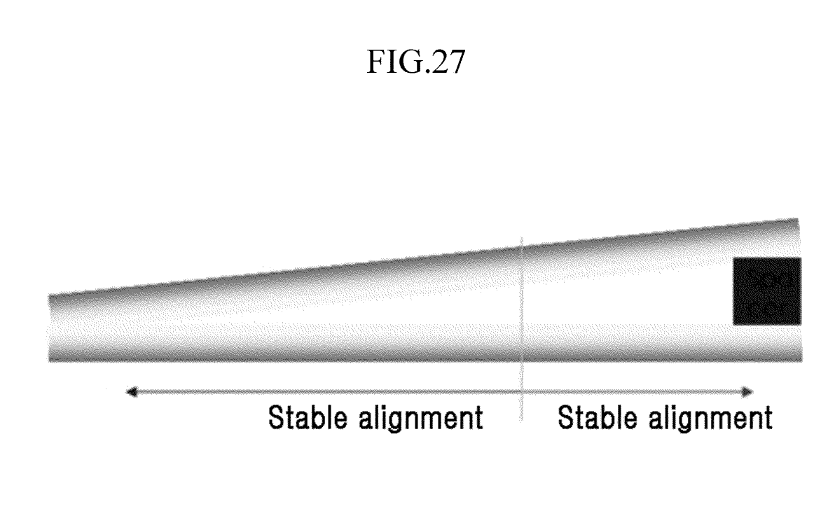

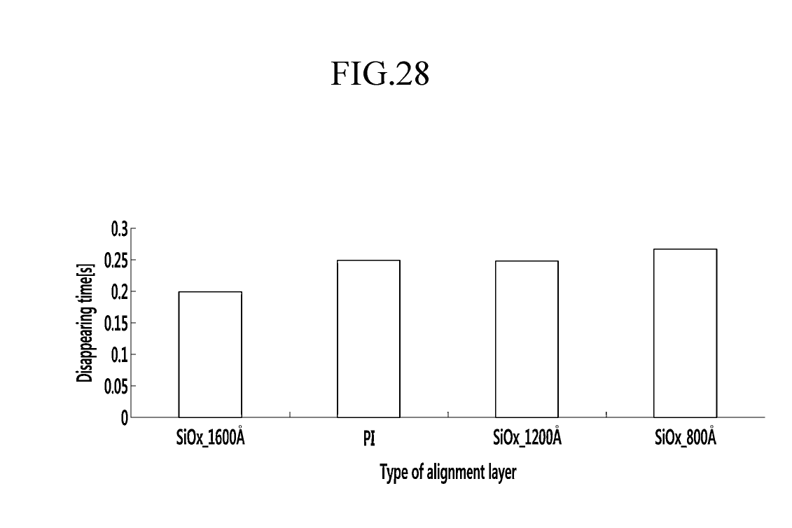

In FIG. 27, a pixel (wedge cell) which has a slanted cell gap is assumed and the alignment force therein is checked. As illustrated in FIG. 27, it is expected that as the cell gap is increased, the liquid crystal alignment is unstable. However, even though the cell gap is increased, all of the polyimide PI alignment layer and the silicon oxide (SiOx) inorganic alignment layer show a stable alignment characteristic so that the alignment forces cannot be compared based on the alignment instability. However, an alignment stabilized time by a finger print F/P can be relatively compared, which will be described with reference to FIG. 28.

FIG. 28 is a diagram illustrating a time when a trace (finger print trace) caused by fingers disappears, which is compared for every alignment layer. As illustrated in FIG. 28, a finger print disappearing time in the wedge cell, is shortened as the inorganic alignment layer thickness is increased, which means that the alignment force is increased as the inorganic alignment layer thickness is increased. Therefore, the finger print disappearing time of the silicon oxide (SiOx) inorganic alignment layer may secure the equal or higher characteristic when compared with the polyimide PI alignment layer.

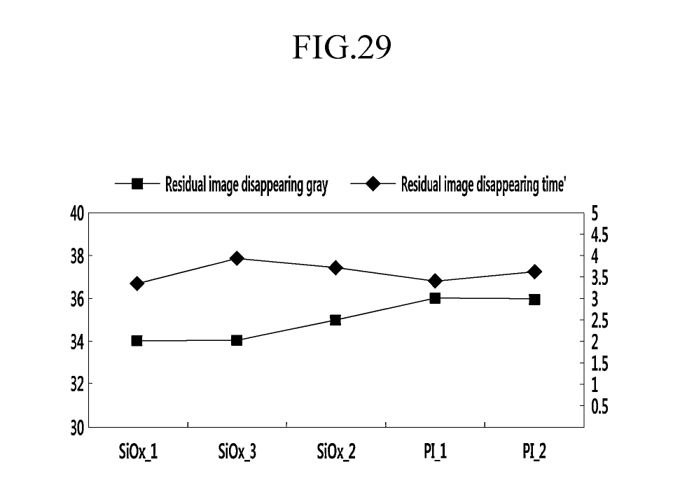

To evaluate the alignment force of an actual panel, after forming the inorganic alignment layer in the actual panel the finger print disappearing time is compared to deduct the result as illustrated in FIG. 29. When the content of FIG. 29 is summarized, it is understood the disappearing time of the polyimide PI alignment layer is approximately 3.55 seconds and the disappearing time of the silicon oxide (SiOx) inorganic alignment layer is approximately 3.67 seconds, which is substantially same as the disappearing time of the polyimide PI alignment layer. Further, in FIG. 29, the alignment layer is formed on an actual panel and then the finger print disappearing time and a disappearing gray are compared. Here, the silicon oxide (SiOx) inorganic alignment layer is formed with 1200 Å. As illustrated in FIG. 29, the finger print disappearing gray and the disappearing time are similar both in the polyimide PI alignment layer and the silicon oxide (SiOx) inorganic alignment layer. Therefore, it is determined that the alignment forces of the polyimide PI alignment layer and the silicon oxide (SiOx) inorganic alignment layer are at the same level.

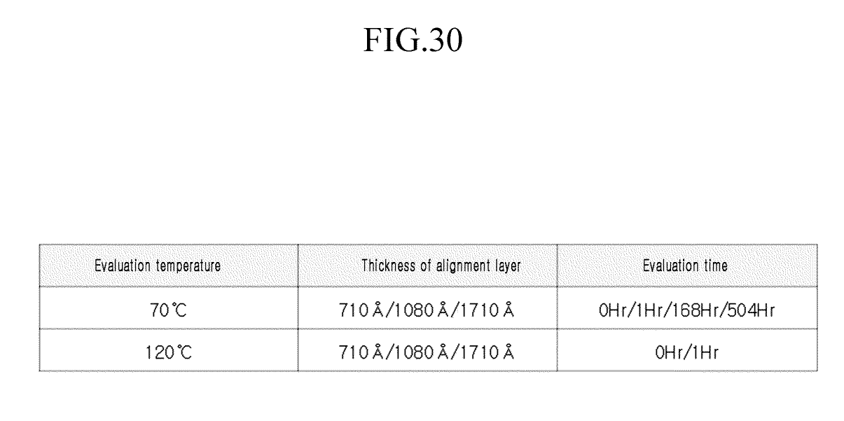

Hereinafter, a long-term thermal stability of the inorganic alignment layer will be described with reference to FIGS. 30 to 35.

The vertical alignment characteristic of the silicon oxide (SiOx) inorganic alignment layer may be adjusted by a high dielectric constant characteristic of the silicon oxide (SiOx) inorganic alignment layer. However, the high dielectric constant characteristic of the silicon oxide (SiOx) inorganic alignment layer is based on an OH component present in the silicon oxide (SiOx) inorganic alignment layer, so that the thermal instability may be present. Therefore, in order to verify the above, the long-term thermal stability is evaluated as described below.

FIG. 30 illustrates a table including a temperature, a thickness, and a time condition which are used to evaluate the thermal stability.

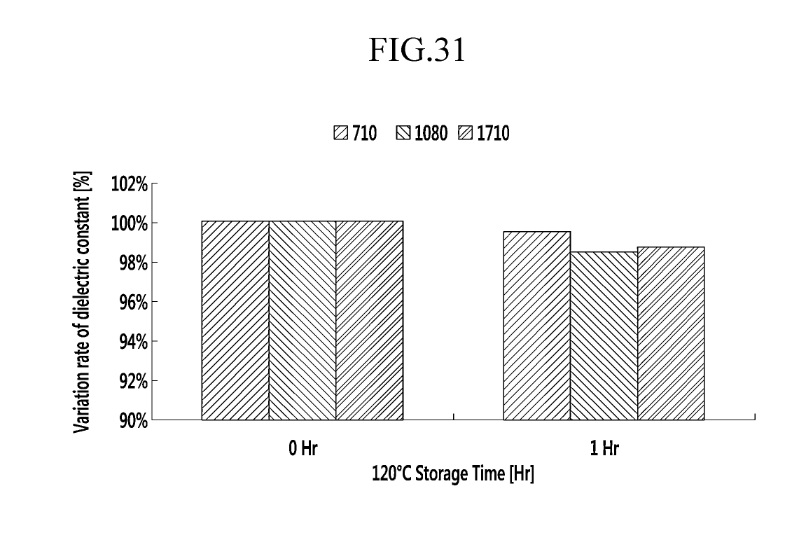

Under an assumption that after forming the inorganic alignment layer, the thermal treatment is performed for one hour (1 Hr) at 120° C., the change in the dielectric constant is measured and the result is illustrated in FIG. 31. As illustrated in FIG. 31, the dielectric constant is very slightly changed by the thermal treatment process for one hour at 120° C. Therefore, even though there is a separate bake process after forming the inorganic alignment layer, the dielectric constant of the inorganic alignment layer does not have a problem.

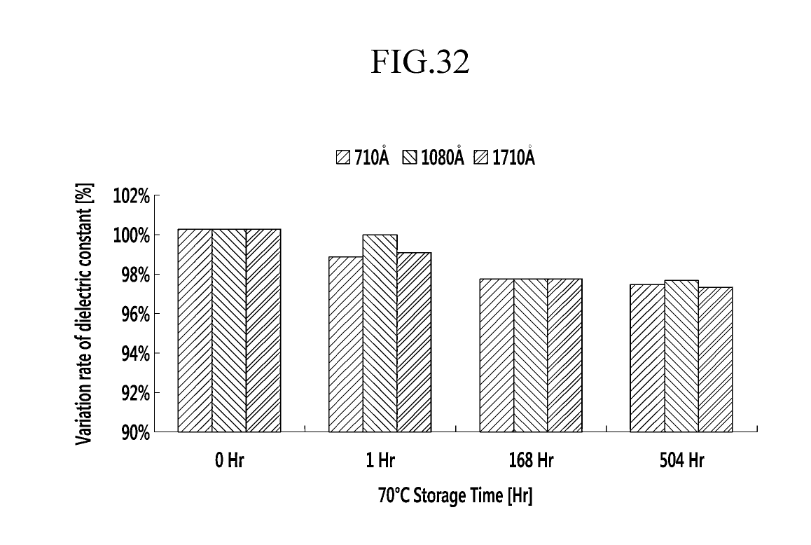

In some embodiments, it is assumed that an operation temperature of the panel is 70° C. and a result which evaluates the stability of the dielectric constant at 70° C. is illustrated in FIG. 32. As illustrated in FIG. 32, the evaluating time is increased, the dielectric constant in the inorganic alignment layer is reduced. However, when the evaluation time exceeds 168 Hr, a reduction of the dielectric constant is reduced and then the dielectric constant is gradually saturated. Further, the dielectric constant which is saturated in 504 Hr shows a value between 6.5 and 7.2 and thus it is determined that there is no problem in the vertical alignment. Therefore, if the dielectric constant of the inorganic alignment layer is set as a vertical alignment adjusting factor, it is determined that the long-term thermal stability is secured.

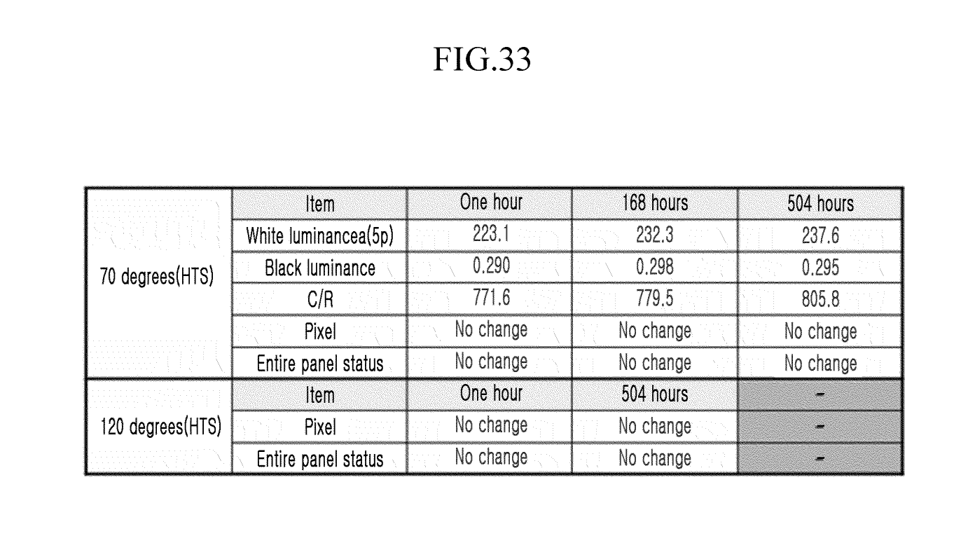

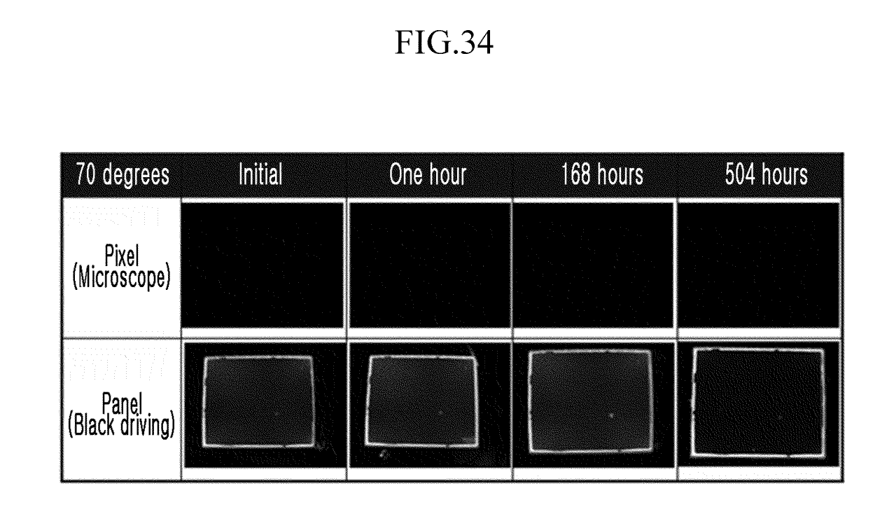

A described above, as a result that evaluates the long-term thermal stability of the dielectric constant, it is determined that the dielectric constant is slightly reduced in accordance with the evaluation time but the reduced range is small, which does not affect the vertical alignment. In order to actually verify this, an actual panel is manufactured and the long-term thermal stability of the liquid crystal alignment characteristic is evaluated and the result is illustrated in FIGS. 33 and 34.

As illustrated in FIGS. 33 and 34, as a result that evaluates the long-term thermal stability under the conditions of 70° C. and 120° C., there is no big difference in the liquid crystal alignment status which displays initial black and there is no difference of the initial comparison status in the driving characteristic evaluation result. Therefore, it is understood that the important thing is that even when the dielectric constant characteristic is slightly reduced, for example, about 7 to 8%, the liquid crystal alignment status is not largely affected and the absolute value of the dielectric constant is maintained.

To confirm the long-term thermal treatment stability, the actual panel is additionally tested, but a characteristic change (VHR (voltage holding ratio) stability and the change in the liquid crystal response speed) of the polyimide PI alignment layer and the silicon oxide (SiOx) inorganic alignment layer is small before and after the thermal treatment.

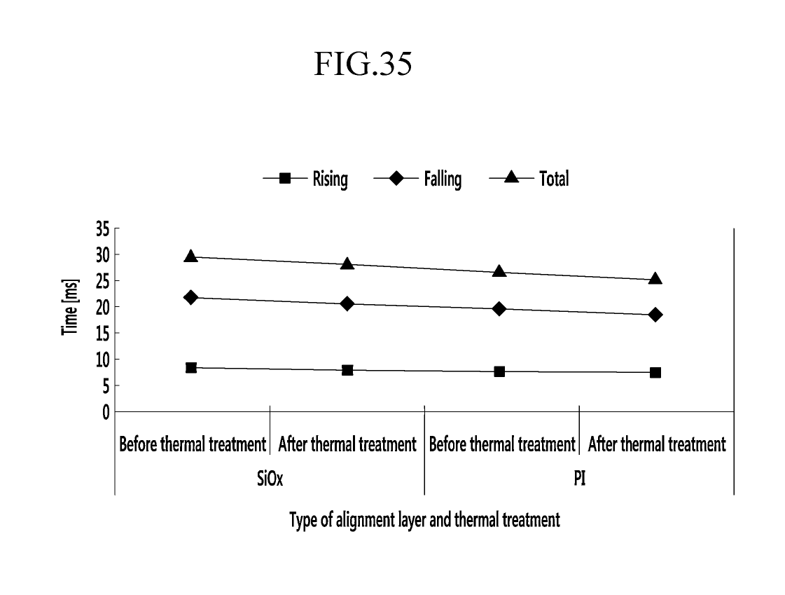

Further, it may be confirmed that after the long-term thermal treatment at 312 Hr, as illustrated in FIG. 35, in the response time characteristic, there is almost no change in the characteristic of the polyimide PI alignment layer and the silicon oxide (SiOx) inorganic alignment layer before and after the thermal treatment. Therefore, it is determined that the long-term thermal stability in the display panel which uses the silicon oxide (SiOx) inorganic alignment layer has no problem in terms of the luminance, black display characteristic, and VHR characteristic and response speed.

As described above, even when the inorganic alignment layer is used, there is no problem to use the inorganic alignment layer as the vertical alignment layer, the long-term thermal stability is good, the process may be simplified, the manufacturing time is reduced and the pixel electrode 192 is not shorted from other wiring lines and the electrode.

As the inorganic alignment layer, various inorganic materials may be used. In this case, if the silicon oxide (SiOx) is used, the thickness may be between about 400 Å and about 1000 Å and as a composition ratio of the silicon oxide (SiOx), x may have a value of 2.3 or 2.4 or between about 2.3 and about 2.4. Further, the dielectric constant of the silicon oxide (SiOx) inorganic alignment layer may be 5, 6 or 7 or between about 5 and about 7.

A condition when the silicon oxide (SiOx) inorganic alignment layer is deposited may be one of the deposition conditions of FIG. 21. That is, when the inorganic alignment layer is deposited, the deposition temperature is about 100 degrees, the power is about 1.2 kW, a deposition pressure is about 1.5 torr, the nitrogen (N₂O) is about 7,000 sccm, SiH₄ is about 120 sccm and the deposition time is between about 27 seconds and about 75 seconds. As a result, an inorganic alignment layer having a thickness of about 400 Å or larger is deposited.

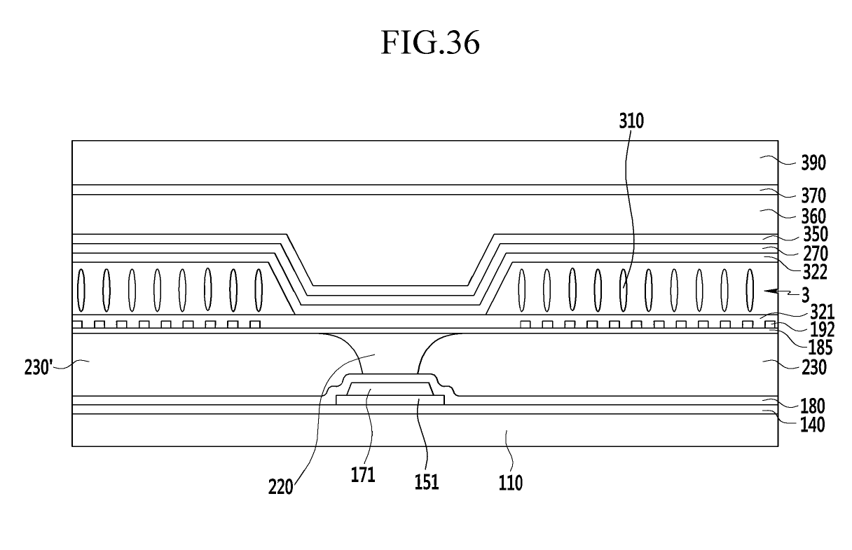

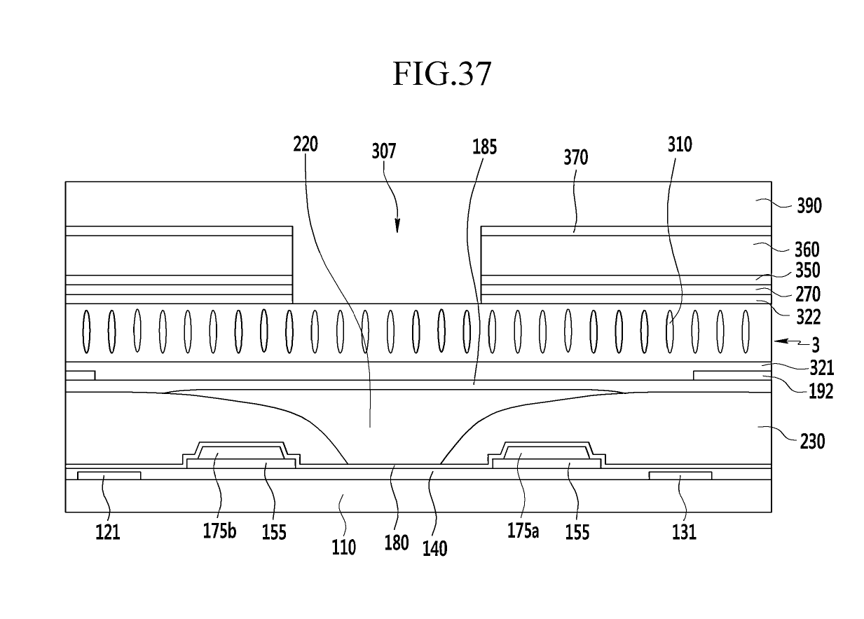

Hereinafter, a structure of the liquid crystal display according to yet another exemplary embodiment of the present disclosure will be described with reference to FIGS. 36 and 37.

FIGS. 36 and 37 are cross-sectional views of the liquid crystal display according to yet another exemplary embodiment of the present disclosure. FIGS. 36 and 37 correspond to FIGS. 2 and 3, but a lower insulating layer 350 is further included which is different from the exemplary embodiment of FIGS. 2 and 3. The lower insulating layer 350 is disposed between the common electrode 270 and the roof layer 360 and may include inorganic insulating material such as silicon nitride (SiNx), silicon oxide (SiOx), silicon nitride oxide (SiOxNy).

The lower insulating layer 350 is etched in the liquid crystal injection hole formation region 307 so as not to be formed therein.

Further, referring to FIGS. 36 and 37, the lower alignment layer 321 and the upper alignment layer 322 not only enclose the liquid crystal layer 3 but also are disposed in another region. That is, the lower alignment layer 321 and the upper alignment layer 322 are formed to overlap in a region between the liquid crystal layer 3 and the liquid crystal layer 3 or adjacent microcavities 305. In some exemplary embodiments, in the region excepting the location which encloses the liquid crystal layer 3, at least one of the lower alignment layer 321 and the upper alignment layer 322 may be omitted.

While this invention has been described in connection with what are presently considered to be practical exemplary embodiments, it will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
an insulation substrate;
a pixel electrode formed on the insulation substrate;
a lower alignment layer formed on the pixel electrode, the lower alignment layer including an inorganic alignment layer formed of an inorganic insulating material;
a liquid crystal layer formed in a microcavity formed on the lower alignment layer;
an upper alignment layer formed along a side and an upper surface of the microcavity, the upper alignment layer including an inorganic alignment layer formed of an inorganic insulating material; and
a common electrode formed on the upper alignment layer,
wherein the upper alignment layer and the lower alignment layer enclose the liquid crystal layer.

2. The liquid crystal display of claim 1, wherein the inorganic insulating material is formed from at least one of silicon oxide (SiOx), silicon nitride (SiNx), silicon carbide (SiCx), amorphous silicon (a-Si), and FDLC (fluorinated diamond-like carbon).

3. The liquid crystal display of claim 2, wherein the inorganic alignment layer is formed from silicon oxide (SiOx).

4. The liquid crystal display of claim 3, wherein as a composition ratio of the silicon oxide (SiOx), x has a value between about 2.3 and about 2.4.

5. The liquid crystal display of claim 3, wherein a thickness of the upper alignment layer or the lower alignment layer is between about 400 Å and about 1000 Å.

6. The liquid crystal display of claim 3, wherein a dielectric constant of the upper alignment layer or the lower alignment layer is between about 5 and about 7.

7. The liquid crystal display of claim 1, wherein the upper alignment layer and the lower alignment layer overlap between adjacent microcavities.

8. The liquid crystal display of claim 1, wherein the upper alignment layer and the common electrode are curved along the microcavity.

9. The liquid crystal display of claim 1, further comprising a roof layer formed covering at least a part of the common electrode, the roof layer including a pillar shape.

10. The liquid crystal display of claim 9, further comprising an upper insulating layer formed covering at least a part of the roof layer.

11. The liquid crystal display of claim 9, further comprising a lower insulating layer formed between the common electrode and the roof layer.

12. A method of manufacturing a liquid crystal display, comprising:
forming a pixel electrode on an insulation substrate;
forming a lower alignment layer with an inorganic alignment material so as to cover the pixel electrode;
forming a sacrificial layer having a side and an upper surface on the lower alignment layer;
forming an upper alignment layer with an inorganic alignment material on the side and the upper surface of the sacrificial layer;
forming a common electrode to cover the upper alignment layer;
forming a roof layer comprising a pillar to cover the common electrode;
forming a liquid crystal injection hole to expose the sacrificial layer;
removing the sacrificial layer exposed through the liquid crystal injection hole to form a microcavity; and
injecting liquid crystal molecules in the microcavity to form a liquid crystal layer.

13. The method of claim 12, wherein the inorganic insulating material is formed from at least one of silicon oxide (SiOx), silicon nitride (SiNx), silicon carbide (SiCx), amorphous silicon (a-Si), and FDLC (fluorinated diamond-like carbon).

14. The method of claim 13, wherein the inorganic alignment layer is formed from silicon oxide (SiOx).

15. The method of claim 14, wherein as a composition ratio of the silicon oxide (SiOx), x has a value between about 2.3 and about 2.4.

16. The method of claim 14, wherein a thickness of the upper alignment layer or the lower alignment layer is between about 400 Å and about 1000 Å.

17. The method of claim 14, wherein a dielectric constant of the upper alignment layer or the lower alignment layer is between about 5 and about 7.

18. The method of claim 12, wherein the upper alignment layer or the lower alignment layer is deposited under a condition that a deposition temperature is about 100° C., a deposition pressure is about 1.5 torr, nitrogen (N₂O) is about 7000 sccm, SiH₄ is about 120 sccm and the deposition time is between about 27 seconds and about 75 seconds.

19. The method of claim 12, wherein the forming of the lower alignment layer or the upper alignment layer comprises removing the inorganic alignment layer deposited on a pad.

20. The method of claim 12, wherein the forming of the lower alignment layer or the upper alignment layer further comprises performing washing after forming the inorganic alignment layer with the inorganic alignment material.
